(19) United States
(12) Patent Application Publication
(10) Pub. No.: US 2025/0088700 A1
(43) Pub. Date: Mar. 13, 2025

(54) METHOD FOR LIVE STREAMING INTERACTION AND ELECTRONIC DEVICE

(71) Applicant: BEIJING DAJIA INTERNET INFORMATION TECHNOLOGY CO., LTD., Beijing (CN)

(72) Inventors: Shuo YANG, Beijing (CN); Ye TANG, Beijing (CN)

(21) Appl. No.: 18/623,358

(22) Filed: Apr. 1, 2024

(30) Foreign Application Priority Data
Sep. 11, 2023 (CN) 202311166406.2

(51) Int. Cl. H04N 21/431; H04N 21/2187

(52) U.S. Cl. CPC H04N 21/4312; H04N 21/2187

(57) ABSTRACT

A method for live streaming interaction is provided. The method includes: displaying a first anchor object in a first live-streaming window and a second anchor object in a second live-streaming window; determining, in the case that the first anchor object in the first live-streaming window makes a preset action, an interactive special effect associated with the preset action, the interactive special effect comprising an interactive element; and displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

This application is based on and claims priority to Chinese Patent Application No. 202311166406.2, filed on Sep. 11, 2023, the disclosure of which is herein incorporated by reference in its entirety.

### TECHNICAL FIELD

The present disclosure relates to the field of multimedia technologies, and in particular, relates to a method for live streaming interaction and an electronic device.

### BACKGROUND

In recent years, live streaming has become popular throughout public life. Despite the increasing popularity of multi-player interactive scenarios in live-streaming rooms, interactions between anchors are limited to the anchor's personal expressiveness. For example, in the case of a two-player battle (PK) in a live-streaming room, each anchor object interacts with viewer objects in the live-streaming room to prompt the viewer objects to hit the like button or give gifts to the anchor object, so as to compare the number of likes or gifts with the other anchor object participating in the PK.

### SUMMARY

The present disclosure provides a method for live streaming interaction and an electronic device, with simple operation. The technical solutions of the present disclosure are as follows.

According to an aspect of embodiments of the present disclosure, a method for live streaming interaction is provided. The method includes:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

According to another aspect of the embodiments of the present disclosure, an apparatus for live streaming interaction is provided. The apparatus includes:
a display unit, configured to display a first anchor object in a first live-streaming window and a second anchor object in a second live-streaming window; and
a determining unit, configured to determine, in the case that the first anchor object in the first live-streaming window makes a preset action, an interactive special effect associated with the preset action, the interactive special effect including an interactive element; and
the display unit is further configured to display the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In some embodiments, the determining unit includes:
a recognizing subunit, configured to acquire, in the case that the first anchor object in the first live-streaming window makes the preset action, an action content and an action direction by recognizing the preset action; and
a determining subunit, configured to determine the interactive special effect based on the action content and at least one of the action direction or a preset special effect.

In some embodiments, the action direction is to indicate the second live-streaming window; and the determining subunit is configured to determine the interactive special effect based on the action direction, the interactive special effect being that the interactive element moves from the first live-streaming window to the second live-streaming window indicated by the action direction.

In some embodiments, the action content is a body action of the first anchor object, the body action includes at least one of a facial expression, a head action, a limb action, or a torso action, and the preset special effect is a body special effect; and the determining subunit is configured to determine the interactive special effect based on the body action of the first anchor object and the body special effect.

In some embodiments, the body action is a facial expression of the first anchor object, and the body special effect is an expression special effect; and the determining subunit is configured to determine the interactive special effect based on the facial expression of the first anchor object and the expression special effect.

In some embodiments, the determining subunit is configured to generate, based on the facial expression of the first anchor object and the expression special effect, an interactive special effect including the interactive element, the interactive element being a facial part of the first anchor object, and the interactive special effect being that the facial part of the first anchor object moves from the face of the first anchor object to the body of the second anchor object in the second live-streaming window.

In some embodiments, the determining subunit is configured to use an expression special effect corresponding to the facial expression of the first anchor object as an interactive element in the interactive special effect, the interactive special effect being that the expression special effect moves from the face of the first anchor object to the body of the second anchor object in the second live-streaming window.

In some embodiments, the action content is a body action of the first anchor object, the body action including at least one of a facial expression, a head action, a limb action, or a torso action, and the preset special effect is a body special effect, the body special effect being a movement process of an interactive prop; and the determining subunit is configured to determine, in the case that the interactive prop touches the first live-streaming window, a moving track of the interactive prop based on an action direction of the body action, and determine the interactive special effect based on the moving track, the interactive special effect being that the interactive prop starts from the first live-streaming window and moves to a target position of the second live-streaming window along the moving track.

In some embodiments, the target position of the second live-streaming window is a position where a boundary of the second live-streaming window is located, and the display unit is further configured to update and display the score of the first anchor object in the case that the interactive prop touches the boundary of the second live-streaming window; and

the display unit is further configured to update and display, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, the target position of the second live-streaming window is a position where a virtual target ring of the second live-streaming window is located; and the display unit is further configured to display at least one virtual target ring of the second live-streaming window, each virtual target ring corresponding to a score, and update and display, in the case that the interactive prop touches the virtual target ring, a score of the anchor object based on a score of the virtual target ring.

In some embodiments, the apparatus further includes:
a detecting unit, configured to detect a boundary of the first live-streaming window based on a position of the first live-streaming window, and determine, in the case that a boundary of the interactive prop is collided with the boundary of the first live-streaming window, that the interactive prop touches the first live-streaming window.

In some embodiments, the apparatus further includes a processing unit configured to determine, in the case that the interactive prop touches the first live-streaming window, a moving speed of the interactive prop based on an action parameter of the body action and an elastic parameter of the interactive prop;
the processing unit is further configured to determine, based on a boundary of the interactive prop and a boundary of the first live-streaming window, a collision position of the interactive prop with the first live-streaming window; and
the determining unit is configured to determine the interactive special effect based on the moving track, the moving speed, and the collision position, the interactive special effect being that the interactive prop starts from the collision position and moves to the target position of the second live-streaming window at the moving speed along the moving track.

In some embodiments, the interactive special effect includes a first interactive element and a second interactive element, the first interactive element being configured to represent interaction progress, and the second interactive element being configured to present an interaction mode between anchor objects; and
the display unit is further configured to display, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state; display, in the case that an interaction duration reaches a preset duration, that the first interactive element is converted from the first form to a second form, the second form being configured to represent that the first interactive element is currently in an interaction quit state; and use, in the case that the first interactive element is in the second form, an anchor object in a live-streaming window where the second interactive element is currently located as a target object.

In some embodiments, the display unit is further configured to display a preset quantity of virtual bricks and the interactive element; display, based on an action direction of the preset action of the first anchor object, a movement of the first live-streaming window according to the action direction; display, in the case that the first live-streaming window touches the interactive element, that the interactive element rebounds from the first live-streaming window; and display, in the case that the interactive element touches the virtual bricks, a disappearing special effect of the virtual bricks.

In some embodiments, the display unit is further configured to display, in the case that the interactive element touches the second live-streaming window, that the interactive element rebounds from the second live-streaming window.

According to another aspect of the embodiments of the present disclosure, an electronic device is provided. The electronic device includes:
one or more processors; and
a memory configured to store one or more program codes executable by the one or more processors;
wherein the one or more processors, when loading and executing the one or more program codes, are caused to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

According to another aspect of the embodiments of the present disclosure, a computer-readable storage medium is provided. The computer-readable storage medium storing at least one instruction therein, wherein the at least one instruction, when executed by a processor of an electronic device, causes the electronic device to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

According to another aspect of the embodiments of the present disclosure, a computer program product including at least one computer program/instruction is provided. The at least one computer program/instruction, when executed by a processor of an electronic device, causes the electronic device to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In a method for live streaming interaction provided by the embodiments of the present disclosure, an action in a live-streaming window of an anchor object can be captured in the interaction process of a plurality of anchor objects, an interactive special effect triggered by a preset action can be determined when the anchor object makes the preset action, and then the movement of an interactive element in the interactive special effect from the live-streaming window where the anchor object is located to other live-streaming windows where other anchor objects are located is displayed, to present the interactive special effect between the anchor object and other anchor objects. An anchor object does not need to select an interaction mode each time for interaction, and can achieve the interaction with other anchor objects only by making a preset action, such that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

### BRIEF DESCRIPTION OF THE DRAWINGS

FIG. 1 is a schematic diagram illustrating an implementation environment of a method for live streaming interaction according to an exemplary embodiment;

FIG. 2 is a flowchart illustrating a method for live streaming interaction according to an exemplary embodiment;

FIG. 3 is a flowchart illustrating another method for live streaming interaction according to an exemplary embodiment;

FIG. 4 is a schematic live-streaming page illustrating a first interactive special effect according to an exemplary embodiment;

FIG. 5 is a schematic live-streaming page illustrating a second interactive special effect according to an exemplary embodiment;

FIG. 6 is a schematic live-streaming page illustrating a third interactive special effect according to an exemplary embodiment;

FIG. 7 is a schematic live-streaming page illustrating a fourth interactive special effect according to an exemplary embodiment;

FIG. 8 is a schematic live-streaming page illustrating a fifth interactive special effect according to an exemplary embodiment;

FIG. 9 is a schematic live-streaming page illustrating a sixth interactive special effect according to an exemplary embodiment;

FIG. 10 is a schematic live-streaming page illustrating a seventh interactive special effect according to an exemplary embodiment;

FIG. 11 is a flowchart illustrating an interaction based on a facial expression of an anchor object according to an exemplary embodiment;

FIG. 12 is a flowchart illustrating interaction based on an interactive prop according to an exemplary embodiment;

FIG. 13 is a block diagram illustrating an apparatus for live streaming interaction according to an exemplary embodiment;

FIG. 14 is a block diagram illustrating another apparatus for live streaming interaction according to an exemplary embodiment; and

FIG. 15 is a block diagram illustrating a terminal according to an exemplary embodiment.

### DETAILED DESCRIPTION

In order to make the technical solutions of the present disclosure better understood, the technical solutions in the embodiments of the present disclosure will be clearly and completely described below with reference to the accompanying drawings.

It should be noted that the information (including, but not limited to, user device information, user personal information, etc.), data (including, but not limited to, data for analysis, stored data, displayed data, etc.) and signals, which are referred to in the present disclosure, are authorized by the user or fully authorized by various parties, and the collection, use and processing of the relevant data are required to comply with relevant laws and regulations and standards in relevant countries and regions. For example, the head pictures of the anchor objects involved in the present disclosure are acquired with sufficient authorization.

In order to describe the solutions more clearly, the names involved are explained below.

Facial action recognition system (FARS) refers to a system that is integrated by combining key technologies of face detection and action capture, and is capable of achieving face key point detection, face part recognition, action track recognition, and the like.

Magic expression system (MES) refers to a dynamic effect generation system that is based on a series of basic frames such as game frames, adobe after effects (AE) templates, particle systems, word systems, and beauty and makeup, and is capable of generating various complex dynamic effects.

Collision detection system (CDS) refers to a system that detects whether an object collides or not by calculating whether boundaries are overlapped or not, and gives a corresponding reaction force to the object when the object collides by setting an elastic coefficient.

Supplemental enhancement information (SEI) refers to a feature that is defined in a video stream and provides additional information for the video stream. In current streaming media, some video-independent information, such as lyrics, data in a terminal of anchor in a live-streaming process, may be added to achieve synchronous display. The SEI may be added either at coding time or at transmission time.

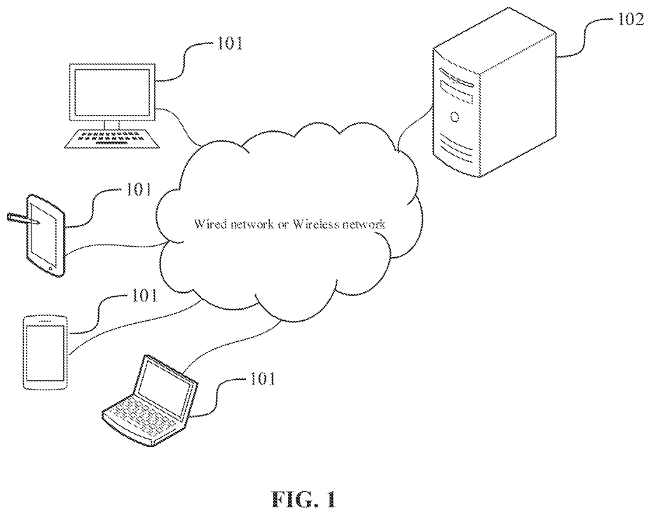

FIG. 1 is a schematic diagram illustrating an implementation environment of a method for live streaming interaction according to an exemplary embodiment. Taking an electronic device serving as a terminal as an example, referring to FIG. 1, the implementation environment specifically includes a terminal 101 and a server 102. The terminal 101 is an electronic device, and is at least one of a smart phone, a smart watch, a desktop computer, a laptop computer, a moving picture experts group audio layer III (MP3) player, a moving picture experts group audio layer IV (MP4) player, a laptop portable computer, and other devices. An application program supporting the live streaming is running on the terminal 101. The application program may be a live-streaming application program, a communication application program, a conference application program, or the like, which is not limited in the embodiments of the present disclosure. A user logs in the application program through the terminal 101 to acquire services provided by the application program. The terminal 101 can be connected to the server 102 via a wireless network or a wired network, and further can be connected to other terminals through the server 102.

The terminal 101 generally refers to one of a plurality of terminals, and the embodiments of the present disclosure are illustrated only by using the terminal 101. Those skilled in the art can know that the number of the terminals may be more or fewer. For example, the number of the terminals may be only a few, or the number of the devices may be tens or hundreds, or more, and the number and the type of the terminals are not limited in the embodiments of the present disclosure.

The server 102 is at least one of a server, a plurality of servers, a cloud computing platform, and a virtualization center. The server 102 can be connected to the terminal 101 and other terminals via a wireless network or a wired network, and the server 102 can provide background services for the application programs supporting the live streaming. In some embodiments, the number of the servers described above is more or less, which is not limited in the embodiments of the present disclosure. In addition, the server 102 further includes other functional servers so as to provide more comprehensive and diverse services.

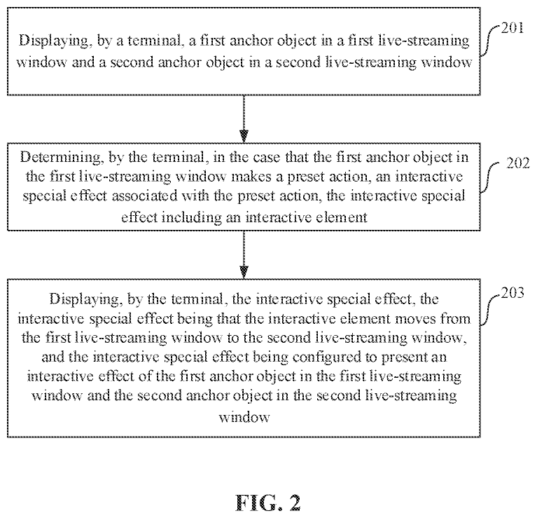

FIG. 2 is a flowchart illustrating a method for live streaming interaction according to an exemplary embodiment. Referring to FIG. 2, the method for live streaming interaction is applied in a terminal and includes the following steps.

In step 201, the terminal displays, on a live-streaming page, a first anchor object in a first live-streaming window and a second anchor object in a second live-streaming window.

In the embodiments of the present disclosure, the terminal is a terminal operated by the first anchor object. The first anchor object interacts with at least one second anchor object via the terminal. The number of the second anchor objects is not limited in the embodiments of the present disclosure. In the interaction process of the first anchor object and the at least one second anchor object, the terminal displays a first live-streaming window of the first anchor object and a second live-streaming window of the at least one second anchor object. For any live-streaming window, the terminal displays the corresponding live-streaming content of the anchor in the live-streaming window. For example, the first live-streaming window includes a first anchor object, and the second live-streaming window includes a second anchor object. Accordingly, the terminal displays, in response to a live-streaming operation of the first anchor object, a head picture of the first anchor object in the first live-streaming window.

In step 202, the terminal determines, in the case that the first anchor object in the first live-streaming window makes a preset action, an interactive special effect associated with the preset action, the interactive special effect including an interactive element.

In the embodiments of the present disclosure, the terminal detects whether a preset action of the first anchor object occurs or not in the first live-streaming window. The preset action of the first anchor object is a facial expression, a head action, or other body actions, which is not limited in the embodiments of the present disclosure. The terminal determines, in the case that the terminal determines that the first anchor object makes a preset action, an interactive special effect associated with the preset action. The embodiments of the present disclosure do not limit the specific form of the interactive special effect. The interactive special effect includes an interactive element. The interactive element is an interactive prop or a virtual expression, which is not limited in the embodiments of the present disclosure. The interactive special effect refers to a display form of an interactive element, and is movement, flicker, gradual change, or the like of the interactive element, which is not limited in the embodiments of the present disclosure.

In step 203, the terminal displays the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

That is, the terminal displays the movement of the interactive element from the first live-streaming window to the second live-streaming window. In the embodiments of the present disclosure, the interactive special effect is a movement process of the interactive element. That is, the terminal displays the movement of the interactive element to present the interactive special effect.

In some embodiments, the number of the second live-streaming window is at least one, and the terminal determines, according to a preset action made by the first anchor object, the second live-streaming window indicated by the preset action. That is, the terminal finds the second anchor object that the first anchor object wants to interact with according to the preset action made by the first anchor object. The interactive special effect is that the interactive element moves from the first live-streaming window to the second live-streaming window indicated by the preset action. That is, the terminal displays the movement of the interactive element from the first live-streaming window to the second live-streaming window indicated by the preset action, thus achieving the interaction between the first anchor object in the first live-streaming window and the second anchor object in the second live-streaming window through the interactive special effect.

In some embodiments, the terminal adds the data of the interactive special effect to the live-streaming data stream to push the stream to the terminals of all the second anchor objects currently participating in the interaction and the terminals of all viewer objects in the live-streaming rooms, and thus the terminals of other second anchor objects and the terminals of viewer objects in the live-streaming rooms can all display the interactive special effect.

According to the solutions provided in the embodiments of the present disclosure, an action of an anchor object can be captured in the interaction process of a plurality of anchor objects, an interactive special effect triggered by a preset action can be determined when the anchor object makes the preset action, and then the movement of an interactive element in the interactive special effect from the live-streaming window where the anchor object is located to other live-streaming windows where other anchor objects are located is displayed, so as to present the interactive special effect between the anchor object and other anchor objects. In this way, an anchor object does not need to select an interaction mode each time for interaction, and can achieve the interaction with other anchor objects by only making a preset action, resulting a simple way to operate, and improvement of the interaction efficiency. Further, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

In some embodiments, determining, in the case that the first anchor object in the first live-streaming window makes the preset action, the interactive special effect associated with the preset action includes:
acquiring, in the case that the first anchor object in the first live-streaming window makes the preset action, an action content and an action direction by recognizing the preset action; and
determining the interactive special effect based on at least one of the action content, the action direction or a preset special effect.

According to the solutions provided in the embodiments of the present disclosure, the preset action of the first anchor object is recognized to determine the action content and the action direction of the first anchor object, and then the interactive special effect is determined according to at least one of the action content, the action direction, and the preset special effect, such that the generated interactive special effect meets the needs of the first anchor object, the interaction result is ensured to meet the expectation of the first anchor object, which increases the expressiveness and interactive effect of the live-streaming rooms, and provides a more obvious interactive feeling for viewer objects and other anchor objects. This in turn improves the interactive atmosphere and retention, and attracts more viewer objects to the live-streaming room.

In some embodiments, the action direction is to indicate the second live-streaming window; and determining the interactive special effect based on the action content and at least one of the action direction or the preset special effect includes:

determining the interactive special effect based on the action direction, the interactive special effect being that the interactive element moves from the first live-streaming window to the second live-streaming window indicated by the action direction.

In the embodiments of the present disclosure, the interactive element can be controlled to move based on the direction indicated by the action direction of the first anchor object, such that the interaction result is ensured to meet the expectation of the first anchor object, that is, the interactive element can interact with an anchor object indicated by the first anchor object, and the mode of determining the interactive special effect is enriched.

In some embodiments, the action content is a body action of the first anchor object, the body action including at least one of a facial expression, a head action, a limb action, or a torso action, and the preset special effect is a body special effect; and determining the interactive special effect based on the action content and at least one of the action direction or the preset special effect includes:
determining the interactive special effect based on the body action of the first anchor object and the body special effect.

According to the solutions provided in the embodiments of the present disclosure, as the body action can convey the intention of the first anchor object to a certain extent, the interactive special effect is determined based on the body action of the first anchor object and the body special effect, such that the generated interactive special effect can more accurately reflect the interactive intention of the first anchor object, and thus a more accurate interaction is achieved, and the mode of determining the interactive special effect is enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, the body action is a facial expression of the first anchor object, and the body special effect is an expression special effect; and
determining the interactive special effect based on the action content and at least one of the action direction or the preset special effect includes:
determining the interactive special effect based on the facial expression of the first anchor object and the expression special effect.

According to the solutions provided in the embodiments of the present disclosure, as the facial expression can convey the intention of the first anchor object to a certain extent, the interactive special effect is determined based on the facial expression of the first anchor object and the expression special effect, such that the generated interactive special effect can more accurately reflect the interactive intention of the first anchor object, and thus a more accurate interaction is achieved, and the mode of determining the interactive special effect is enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, determining the interactive special effect based on the facial expression of the first anchor object and the expression special effect includes:
generating, based on the facial expression of the first anchor object and the expression special effect, an interactive special effect including the interactive element, the interactive element being a facial part of the first anchor object, and the interactive special effect being that the facial part of the first anchor object moves from a face of the first anchor object to a body of the second anchor object in the second live-streaming window.

According to the solutions provided in the embodiments of the present disclosure, as the facial expression can convey the intention of the first anchor object to a certain extent, the interactive special effect is determined based on the facial expression of the first anchor object and the expression special effect, such that the generated interactive special effect can more accurately reflect the interactive intention of the first anchor object, and thus a more accurate interaction is achieved, and in addition, as the facial part of the first anchor object moves, the facial expression of the first anchor object is deformed in the direction of the second anchor object, so as to present the interactive special effect, such that the mode of determining the interactive special effect is enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, determining the interactive special effect based on the facial expression of the first anchor object and the expression special effect includes:
using an expression special effect corresponding to the facial expression of the first anchor object as an interactive element in the interactive special effect, the interactive special effect being that the expression special effect moves from a face of the first anchor object to a body of the second anchor object in the second live-streaming window.

According to the solutions provided in the embodiments of the present disclosure, the facial expression of the anchor object is associated with the preset special effect, once the facial expression of the first anchor object appears, the corresponding expression special effect is directly used as an interactive element in the interactive special effect, and then the movement of the expression special effect from the face of the first anchor object to the body of the second anchor object in the second live-streaming window indicated by the action direction is displayed. An anchor object does not need to select an interaction mode/manner each time for interaction, and can achieve the interaction with other anchor objects by simply making an action, such that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

In some embodiments, the action content is a body action of the first anchor object, the body action including at least one of a facial expression, a head action, a limb action, or a torso action, and the preset special effect is a body special effect, the interactive element is an interactive prop, the body special effect being a movement process of an interactive prop; and determining the interactive special effect based on the action content and at least one of the action direction or the preset special effect includes:
determining, in the case that the interactive prop touches the first live-streaming window, a moving track of the interactive prop based on an action direction of the body action; and
determining the interactive special effect based on the moving track, the interactive special effect being that the interactive prop starts from the first live-streaming window and moves to a target position of the second live-streaming window along the moving track.

According to the solutions provided in the embodiments of the present disclosure, a body action of an anchor object can be captured in the interaction process of a plurality of anchor objects, and a moving track of the interactive prop is determined based on the body action of the anchor object, and then the interactive prop moves from the first live-streaming window to a relevant position of the second live-streaming window based on the moving track of the interactive prop, so as to achieve the interaction between the first anchor object and the second anchor object in the second live-streaming window. An anchor object does not need to select an interaction mode each time for interaction, and can achieve the interaction with other anchor objects by just making an action, such that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

In some embodiments, the target position of the second live-streaming window is a position where a boundary of the second live-streaming window is located, and the method further includes at least one of:
updating and displaying a score of the first anchor object in the case that the interactive prop touches the boundary of the second live-streaming window; and
updating and displaying, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

According to the solutions provided in the embodiments of the present disclosure, the first anchor object can control the interactive prop to move to the boundary of the second live-streaming window based on a head action, and in the case that the interactive prop touches the boundary of the second live-streaming window, it is considered that the first anchor object successfully interacts, and the score of the first anchor object is updated and displayed; alternatively, in the case that the interactive prop does not touch the boundary of the second live-streaming window, it is considered that the second anchor object fails to interact with the first anchor object, and the interaction state of the second anchor object is updated to the interaction quit state from the interaction state, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, the target position of the second live-streaming window is a position where a virtual target ring of the second live-streaming window is located; and the method further includes:
displaying at least one virtual target ring of the second live-streaming window, each virtual target ring corresponding to a score; and
updating and displaying, in the case that the interactive prop touches the virtual target ring, a score of the anchor object based on a score of the virtual target ring.

According to the solutions provided in the embodiments of the present disclosure, the first anchor object can control the interactive prop to move to the virtual target ring of the second live-streaming window based on a body action, and in the case that the interactive prop touches the virtual target ring, it is considered that the first anchor object successfully interact, and the score of the first anchor object is updated and displayed, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, the method further includes:
detecting a boundary of the first live-streaming window based on a position of the first live-streaming window; and
determining, in the case that a boundary of the interactive prop overlaps the boundary of the first live-streaming window, that the interactive prop touches the first live-streaming window.

According to the solutions provided in the embodiments of the present disclosure, whether the boundary of the interactive prop overlaps the boundary of the first live-streaming window or not is detected, such that whether the interactive prop touches the first live-streaming window or not can be determined more accurately, and thus the interactive special effect can be displayed more accurately in the case that it is determined that the interactive prop touches the first live-streaming window subsequently, thereby ensuring a better interactive effect of the interactive special effect.

In some embodiments, the method further includes:
determining, in the case that the interactive prop touches the first live-streaming window, a moving speed of the interactive prop based on an action parameter of the body action and an elastic parameter of the interactive prop; and
determining, based on a boundary of the interactive prop and a boundary of the first live-streaming window, a collision position of the interactive prop with the first live-streaming window; and
determining the interactive special effect based on the moving track includes:
determining the interactive special effect based on the moving track, the moving speed, and the collision position, the interactive special effect being that the interactive prop starts from the collision position and moves to the target position of the second live-streaming window at the moving speed along the moving track.

According to the solutions provided in the embodiments of the present disclosure, the moving speed of the interactive prop is determined based on the action speed of the body action of the anchor object and the elastic parameter of the interactive prop, such that the interactive prop can move to the relevant position of the second live-streaming window according to the expected speed of the anchor object, which conforms to the intention of the anchor object and improves the interactive experience of the anchor object.

In some embodiments, the interactive special effect includes a first interactive element and a second interactive element, the first interactive element being configured to represent interaction progress, and the second interactive element being configured to present an interaction mode between anchor objects; and displaying the interactive special effect includes:
displaying, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in the case that an interaction duration reaches a preset duration, that the first interactive element is converted from the first form to a second form, the second form being configured to represent that the first interactive element is currently in an interaction quit state; and
using, in the case that the first interactive element is in the second form, an anchor object in a live-streaming window where the second interactive element is currently located as a target object.

According to the solutions provided in the embodiments of the present disclosure, the interactive special effect includes a first interactive element and a second interactive element, in the case that the first interactive element is in a first form, a plurality of anchor objects interact within a preset duration, and in the interaction process, the anchor object controls the second interactive element to move to the second live-streaming window based on a preset action, so as to achieve the interaction between the anchor objects; and in the case that the interaction duration reaches the preset duration, the interaction is stopped, and the anchor object of the live-streaming window where the second interactive element is currently located is used as the target object, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

In some embodiments, the method further includes:
displaying a preset quantity of virtual bricks and the interactive element;
displaying, based on an action direction of the preset action of the first anchor object, the movement of the first live-streaming window according to the action direction;
displaying, in the case that the first live-streaming window touches the interactive element, that the interactive element rebounds from the first live-streaming window; and
displaying, in the case that the interactive element touches the virtual bricks, a disappearing special effect of the virtual bricks.

According to the solutions provided in the embodiments of the present disclosure, based on the preset action of the first anchor object, the first live-streaming window of the first anchor object is controlled to move to touch the interactive element, and then the interactive element rebounds from the first live-streaming window to touch the virtual bricks, and the interaction between the anchor object and the virtual bricks is achieved, such that the live-streaming gameplay of a single anchor object is enriched, the expressiveness and the interactive effect of the live-streaming room are increased, and a more obvious interactive feeling is provided for viewer objects, which is conducive to improving the interactive atmosphere and retention in the live-streaming room, and attracting more viewer objects to the live-streaming room.

In some embodiments, the method further includes:
displaying, in the case that the interactive element touches the second live-streaming window, that the interactive element rebounds from the second live-streaming window.

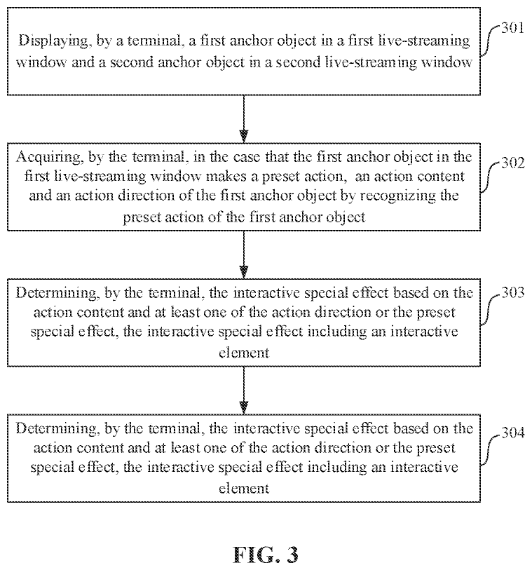

FIG. 2 is a flowchart illustrating only a basic flow of the present disclosure, and the solutions provided by the present disclosure are further explained below based on a specific implementation manner; and FIG. 3 is a flowchart illustrating another method for live streaming interaction according to an exemplary embodiment. Taking an electronic device serving as a terminal of a first anchor object as an example, referring to FIG. 3, the method includes the following steps.

In step 301, the terminal displays a first anchor object in a first live-streaming window and a second anchor object in a second live-streaming window on a live-streaming page.

The number of the second live-streaming windows is at least one, that is, the number of the second live-streaming windows may be one or more. In the embodiments of the present disclosure, the first anchor object interacts with at least one second anchor object via the terminal, i.e., the interactive live streaming is performed among a plurality of anchor objects. In the embodiments of the present disclosure, “a plurality of” refers to two or more. That is, in the interaction process of a plurality of anchor objects, the terminal displays the respective corresponding live-streaming windows of the plurality of anchor objects currently participating in the interaction. Each anchor object provides, through the live-streaming window, the live-streaming content for viewer objects in the live-streaming room and other anchor objects. For any live-streaming window, the terminal displays the corresponding anchor object in the live-streaming window. Accordingly, the terminal can recognize the preset action made by the anchor object, and the preset action is not limited in the embodiments of the present disclosure.

In step 302, in the case that the first anchor object in the first live-streaming window makes a preset action, the terminal acquires an action content and an action direction of the first anchor object by recognizing the preset action of the first anchor object.

In the embodiments of the present disclosure, in the case that the first anchor object in the first live-streaming window makes a preset action, the terminal captures the preset action and recognizes the preset action, so as to acquire the action content and the action direction of the first anchor object. The preset action is a body action of the first anchor object, which is not limited in the embodiments of the present disclosure. The limb action of the first anchor object includes at least one of a facial expression, a head action, a limb action, or a torso action, which is not limited in the embodiments of the present disclosure.

In some embodiments, in the case that the preset action is a facial expression or a head action, the terminal recognizes a key point in the face of the first anchor object through the facial action recognition system (FARS) to determine an action track of the key point in the face of the first anchor object, thereby determining the preset action of the first anchor object and the direction indicated by the preset action. For example, the terminal recognizes, through the FARS, that the facial expression of the first anchor object is pouting and the direction corresponding to the pouting. Alternatively, the terminal recognizes, through the FARS, that the action of the first anchor object is head shaking and the direction of the head shaking.

In some embodiments, in the case that the preset action is a limb action or a torso action, the terminal recognizes a key point in the limb of the first anchor object through the human body recognition system to determine an action track of the key point in the limb of the first anchor object, thereby determining the preset action of the first anchor object and the direction indicated by the preset action. For example, the terminal recognizes, through the human body recognition system, that the limb action of the first anchor object is hand raising and the direction corresponding to fingers. Alternatively, the terminal recognizes, through the human body recognition system, that the torso action of the first anchor object is jumping and the jumping direction. The human body recognition system and the FARS belong to the same system or are two separate systems, which are not limited in the embodiments of the present disclosure.

In some embodiments, the terminal recognizes a preset action of the first anchor object and also acquires an action parameter of the preset action, the action parameter including at least one of an action speed or an acceleration of a key point in the face or body of the first anchor object. Subsequently, the terminal determines the display speed of the interactive special effect based on the action parameter of the preset action. That is, the terminal further determines the display speed of the interactive special effect based on the speed of the preset action of the first anchor object.

In step 303, the terminal determines the interactive special effect based on the action content and at least one of the action direction or the preset special effect, the interactive special effect including an interactive element.

In the embodiments of the present disclosure, the action content is a body action of the first anchor object. The body action includes at least one of a facial expression, a head action, a limb action, or a torso action. That is, the action content of the preset action is any of a facial expression, a head action, a limb action or a torso action, or a combination of two or more actions, which is not limited in the embodiments of the present disclosure. The preset special effect is a body special effect corresponding to a body action, each body action corresponding to a respective body special effect, and the body special effect is an expression special effect or is a movement process of an interactive prop, which is not limited in the embodiments of the present disclosure. The terminal determines the interactive special effect based on the action content and at least one of the action direction or the preset special effect.

In some embodiments, the terminal determines the interactive special effect based on the action direction, the interactive special effect is the effect that the interactive element moves from the first live-streaming window to the second live-streaming window indicated by the action direction. The number of the second live-streaming windows is one or more, the action direction indicates that a second live-streaming window exists, and the second live-streaming window indicated by the action direction is a second live-streaming window located in the direction indicated by the action direction. Therefore, the interactive special effect is the effect that the interactive element moves from the first live-streaming window to the second live-streaming window indicated by the action direction, such that the interaction between the first anchor object in the first live-streaming window and the second anchor object in the specified second live-streaming window is achieved.

In some embodiments, the terminal determines the interactive special effect based on the body action of the first anchor object and the body special effect. For example, the body action is a facial expression of the first anchor object, and the body special effect is an expression special effect. Then, the process that the terminal determines the interactive special effect based on the body action of the first anchor object and the body special effect includes: the terminal determines the interactive special effect based on the facial expression of the first anchor object and the expression special effect. According to the solutions provided in the embodiments of the present disclosure, as the facial expression can convey the intention of the first anchor object to a certain extent, the interactive special effect is determined based on the facial expression of the first anchor object and the expression special effect, such that the generated interactive special effect can more accurately reflect the interactive intention of the first anchor object, and thus a more accurate interaction is achieved, and the mode of determining the interactive special effect is enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room. In some embodiments, the terminal generates the interactive special effect based on the facial expression and the expression special effect; or the terminal directly uses the expression special effect corresponding to the facial expression as the interactive special effect, which is not limited in the embodiments of the present disclosure.

In some embodiments, the terminal generates the interactive special effect based on the facial expression and the expression special effect. Correspondingly, the process that the terminal determines the interactive special effect based on the facial expression of the first anchor object and the expression special effect includes: the terminal generates an interactive special effect including the interactive element based on the facial expression of the first anchor object and the expression special effect, the interactive element is a facial part of the first anchor object, and the facial part is a facial part in a head picture of the first anchor object. Then, the interactive special effect is that the facial part of the first anchor object moves from the face of the first anchor object to the body of the second anchor object in the second live-streaming window. The facial expression of the first anchor object in the head picture of the first anchor object is deformed due to the movement of the facial part of the first anchor object. In some embodiments, the interactive special effect includes a movement process of a facial part of the first anchor object and the expression special effect. According to the solutions provided in the embodiments of the present disclosure, as the facial expression can convey the intention of the first anchor object to a certain extent, the interactive special effect is determined based on the facial expression of the first anchor object and the expression special effect, such that the generated interactive special effect can more accurately reflect the interactive intention of the first anchor object, and thus a more accurate interaction is achieved, and in addition, the facial expression of the first anchor object is deformed in the direction of the second anchor object to present the interactive special effect, such that the mode of determining the interactive special effect is enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

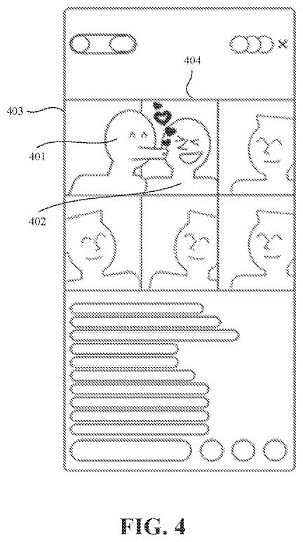

For example, FIG. 4 is a schematic live-streaming page illustrating a first interactive special effect according to an exemplary embodiment. Referring to FIG. 4, in the case that the first anchor object 401 makes a pouting action to the second anchor object 402, the terminal recognizes the facial expression of the first anchor object 401, and determines an expression special effect corresponding to the facial expression. For example, the expression special effect is a heart special effect. The terminal generates an interactive special effect according to the facial expression of the first anchor object 401 and the expression special effect. The interactive special effect including a movement process of the mouth of the first anchor object 401 and the expression special effect. That is, as shown in FIG. 4, the terminal of a first anchor object displays, on the live-streaming page, a first anchor object 401 in a first live-streaming window 403, and a second anchor object 402 in a second live-streaming window 404. The process that the terminal displays the interactive special effect is as follows: the terminal displays that the mouth of the first anchor object 401 is elongated in the direction of the second anchor object 402 until the mouth of the first anchor object 401 sticks to the face of the second anchor object 402, and displays a heart special effect. The heart special effect is a display of a plurality of hearts in the second live-streaming window 404 of the second anchor object 402. The elongation process of the mouth of the first anchor object 401 and the heart special effect described above constitute a complete interactive special effect.

In some embodiments, the terminal uses a facial expression special effect as the interactive element; and determines the interactive special effect based on the facial expression of the first anchor object and the expression special effect. The interactive special effect constitutes a deformation of the facial expression toward the second live-streaming window and a display of images that convey the feeling of the first anchor object to the second anchor object. The images are heart in the illustrated example. In some embodiments, the terminal directly uses an expression special effect corresponding to the facial expression as an interactive special effect. Correspondingly, the process that the terminal determines the interactive special effect based on the facial expression of the first anchor object and the expression special effect includes: the terminal uses the expression special effect corresponding to the facial expression of the first anchor object as an interactive element in the interactive special effect. The interactive special effect is that the expression special effect moves from the face of the first anchor object to the body of the second anchor object in the second live-streaming window. According to the solutions provided in the embodiments of the present disclosure, the facial expression of the anchor object is associated with the preset special effect, once the first anchor object makes a facial expression, the corresponding expression special effect is directly used as an interactive element in the interactive special effect, and then the movement of the expression special effect from the face of the first anchor object to the body of the second anchor object in the second live-streaming window is displayed. An anchor object does not need to select an interaction mode for interaction each time, and can achieve the interaction with other anchor objects by only making a facial expression, such that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

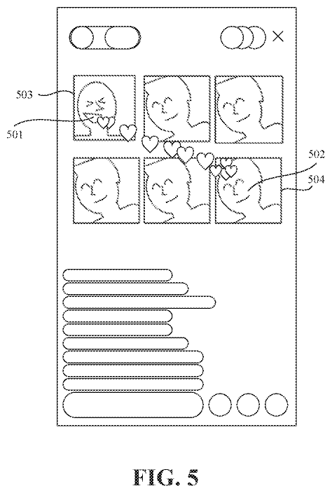

For example, FIG. 5 is a schematic live-streaming page illustrating a second interactive special effect according to an exemplary embodiment. Referring to FIG. 5, in the case that the first anchor object 501 in a first live-streaming window 503 makes a pouting action to the second anchor object 502 in a second live-streaming window 504, the terminal recognizes the facial expression of the first anchor object 501, and determines an expression special effect corresponding to the facial expression. For example, the expression special effect is a heart special effect of displaying hearts on the live-streaming page. The terminal uses the expression special effect corresponding to the facial expression of the first anchor object 501 as an interactive element in the interactive special effect. That is, as shown in FIG. 5, the process that the terminal displays the interactive special effect is as follows: the terminal displays the facial expression (a pouting action by a mouth for example), and the movement of the heart special effect corresponding to the pouting action from the first anchor object 501 to the second anchor object 502. The movement process of the heart special effect from the first anchor object 501 to the second anchor object 502 is the interactive special effect. The interactive special effect achieves the effect of “kiss in the air”.

In some embodiments, the action content is a body action of the first anchor object, the body action includes at least one of a facial expression, a head action, a limb action, or a torso action, and the preset special effect is a body special effect, the body special effect being a movement process of an interactive prop. Correspondingly, the process that the terminal determines the interactive special effect based on the action content and at least one of the action direction or the preset special effect includes: the terminal determines, in the case that the interactive prop touches the first live-streaming window, a moving track of the interactive prop based on the action direction of the body action, and determines the interactive special effect based on the moving track, the interactive special effect is the effect that the interactive prop starts from the first live-streaming window and moves to a target position of the second live-streaming window along the moving track.

That is, in the case that the interactive prop touches the first live-streaming window, the terminal determines the action direction of the body action. Then, the terminal determines the moving track of the interactive prop based on the action direction, and the interactive special effect is formed in the movement process of the interactive prop along the moving track. According to the solutions provided in the embodiments of the present disclosure, a body action of an anchor object can be captured in the interaction process of a plurality of anchor objects, and a moving track of the interactive prop is determined based on the body action of the anchor object, and then the interactive prop moves from the first live-streaming window to a target position of the second live-streaming window based on the moving track of the interactive prop, to achieve the interaction between the first anchor object and the second anchor object in the second live-streaming window. An anchor object does not need to select an interaction mode each time for interaction, and can achieve the interaction with other anchor objects by only making a preset action, such that the method is simple to operate, and can improve the interaction efficiency; and also the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

For example, the body action is a head action, and the terminal controls the movement of the interactive prop based on the head action. In the case that the interactive prop touches the first live-streaming window, the terminal determines the action direction of the head action, and then the terminal determines the moving track of the interactive prop based on the action direction of the head action. Subsequently, the terminal displays the interactive special effect of the interactive prop which starts from the first live-streaming window and moves to the target position of the second live-streaming window along the moving track.

For another example, the body action is a facial expression, and similar to the above solution of controlling the movement of the interactive prop based on the head action, the anchor object may also control the movement of the interactive prop based on the facial expression. In the case that the interactive prop touches the first live-streaming window, the terminal determines the action direction of the facial expression of the first anchor object in the first live-streaming window. Then, the terminal determines the moving track of the interactive prop based on the action direction of the facial expression. Subsequently, the terminal displays the interactive special effect of the interactive prop which starts from the first live-streaming window and moves to the target position of the second live-streaming window along the moving track.

In some embodiments, the terminal detects a boundary of the first live-streaming window based on the position of the first live-streaming window. Then, in the case that the boundary of the interactive prop overlaps the boundary of the first live-streaming window, the terminal determines that the interactive prop touches the first live-streaming window. According to the solutions provided in the embodiments of the present disclosure, whether the boundary of the interactive prop overlaps the boundary of the first live-streaming window or not is detected, such that whether the interactive prop touches the first live-streaming window or not can be determined more accurately, and thus the interactive special effect can be displayed more accurately in the case that it is determined that the interactive prop touches the first live-streaming window subsequently, thereby ensuring a better interactive effect of the interactive special effect. The terminal can set data such as collision detection boundaries and elastic parameters for the live-streaming window and the interactive prop through the collision detection system (CDS). Then, the terminal detects whether the interactive prop touches the live-streaming window or not through the CDS, and the mode of detecting the touch is not limited in the embodiments of the present disclosure. The interactive prop is a virtual ball, a virtual flower, or the like, and the specific form of the interactive prop is not limited in the embodiments of the present disclosure.

In some embodiments, the terminal determines, in the case that the interactive prop touches the first live-streaming window, a moving speed of the interactive prop based on an action parameter of the body action and an elastic parameter of the interactive prop, and determines, based on a boundary of the interactive prop and a boundary of the first live-streaming window, a collision position of the interactive prop with the first live-streaming window. The terminal determines the interactive special effect based on the moving track, the moving speed, and the collision position, the interactive special effect being that the interactive prop starts from the collision position and moves to the target position of the second live-streaming window at the moving speed along the moving track.

That is, the terminal determines the action direction and the action parameter of the body action in the case that the interactive prop touches the first live-streaming window. The action parameter is at least one of a velocity parameter or an acceleration parameter of the body action, which is not limited in the embodiments of the present disclosure. Then, the terminal determines a collision position of the interactive prop and the first live-streaming window based on the boundary of the interactive prop and the boundary of the first live-streaming window. Then, the terminal determines a moving speed of the interactive prop based on an action parameter of the body action and an elastic parameter of the interactive prop. Then, the terminal determines the interactive special effect based on the moving track, the moving speed, and the collision position, the interactive special effect being that the interactive prop starts from the collision position and moves to the target position of the second live-streaming window at the moving speed along the moving track. The elastic parameter of the interactive prop is used to measure the ability of the interactive prop to resist deformation generated by an external force, i.e., the elastic parameter indicates the ability of the interactive prop to recover its original shape after being subjected to an external force. Optionally, the elastic parameter of the interactive prop includes Young's modulus, shear modulus, or Poisson's ratio of the interactive prop. As the interactive method of the embodiments of the present application simulates a scenario in which an external force is applied to the interactive prop through a body movement to cause movement of the interactive prop, the rate of movement of the interactive prop depends on the action parameter of the body movement and the elastic parameter of the interactive prop. According to the solutions provided in the embodiments of the present disclosure, the moving speed of the interactive prop is determined based on the action speed of the body action of the anchor object and the elastic parameter of the interactive prop, such that the interactive prop can move to the target position of the second live-streaming window according to the expected speed of the anchor object, which conforms to the intention of the anchor object and improves the interactive experience of the anchor object.

The target position of the second live-streaming window is a location that has an associated relationship with the second live-streaming window, and the target position may be located within the second live-streaming window, on the boundary of the second live-streaming window, or outside the second live-streaming window, for example, the target position may be located above or below second live-streaming window.

In some embodiments, the target position of the second live-streaming window is a position where a boundary of the second live-streaming window is located, and the interactive prop is controlled to move between the live-streaming windows based on the body actions such as a head action of the anchor objects. Correspondingly, the terminal determines the action direction of the head action of the first anchor object in the case that the interactive prop touches the boundary of the first live-streaming window. Then, the terminal determines the moving track of the interactive prop based on the action direction. Then, the terminal displays a movement of the interactive prop starting from the first live-streaming window and to the boundary of the second live-streaming window indicated by the action direction along the moving track. Then, in the case that the interactive prop touches the boundary of the second live-streaming window, the terminal determines the action direction of the head action of the second anchor object in the second live-streaming window. Then, the terminal determines the moving track of the interactive prop based on the action direction. Then, the terminal displays that the interactive prop starts from the second live-streaming window and moves to the boundary of the live-streaming window indicated by the action direction along the moving track. Similarly, the interactive prop may move back and forth among a plurality of live-streaming windows.

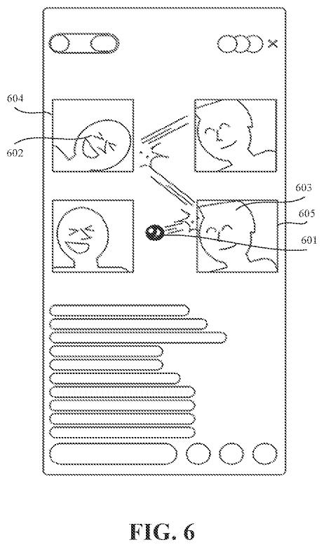

For example, FIG. 6 is a schematic live-streaming page illustrating a third interactive special effect according to an exemplary embodiment. The live-streaming page is displayed on a terminal of a first anchor object. Referring to FIG. 6, the body action is a head action and an interactive prop 601 is a ball like object. In the illustrated action scenario, the interactive prop 601 starts the motion and moves toward to the first anchor object 602 in the first live-streaming window 604. In the case that the interactive prop 601 touches the boundary of the first live-streaming window 604, the terminal determines the action direction of the head action of the first anchor object 602. In the illustrated example, the action direction of the head action of the first anchor object 602 is a direction toward a second anchor object 603 in a second live-streaming window 605. Then, the terminal determines the moving track of the interactive prop 601 based on the action direction. Then, the terminal displays the movement of the interactive prop 601 that starts from the first live-streaming window 604 and moves to the boundary of the second live-streaming window 605 along the moving track. In the case that the interactive prop 601 touches the boundary of the second live-streaming window 605, the terminal determines the action direction of the head action of the second anchor object 603 in the second live-streaming window 605. Then, the terminal determines the next moving track of the interactive prop 601 based on the action direction of the second anchor object 603. Then, the terminal displays that the interactive prop 601 starts from the second live-streaming window 605 and moves toward the boundary of the live-streaming window indicated by the action direction along the moving track, that is, the boundary of the live-streaming window at the bottom left of the live-streaming page.

In some embodiments, the target position of the second live-streaming window is a position where a boundary of the second live-streaming window is located. The terminal updates and displays the score of the first anchor object in the case that the interactive prop touches the boundary of the second live-streaming window. Alternatively, in the case that the interactive prop does not touch the boundary of the second live-streaming window, the terminal updates and displays an interaction state of the second anchor object in the second live-streaming window from a first state to a second state. The first state indicates that the second anchor object is in an interaction state. The second state indicates that the second anchor object is in an interaction quit state. According to the solutions provided in the embodiments of the present disclosure, the first anchor object can control the interactive prop to move to the boundary of the second live-streaming window based on a body action, and in the case that the interactive prop touches the boundary of the second live-streaming window, it can be regarded as a successful interaction of the first anchor, and the score of the first anchor object is updated and displayed; alternatively, in the case that the interactive prop does not touch the boundary of the second live-streaming window, it can be considered that the second anchor object fails to interact with the first anchor object, and the interaction state of the second anchor object is updated to the interaction quit state from the interaction state, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

The terminal displays the interaction state of the second anchor object in a manner of text, brightness of the live-streaming window, color of the live-streaming window, or the like, which is not limited in the embodiments of the present disclosure. For example, in the case that the interactive prop does not touch the boundary of the second live-streaming window, the terminal changes the brightness of the second live-streaming window from the first brightness corresponding to the first state to the second brightness corresponding to the second state. The first brightness is brighter than the second brightness. That is, in the case that the interactive prop does not touch the boundary of the second live-streaming window, the terminal turns down the brightness of the second live-streaming window.

In some embodiments, the target position of the second live-streaming window is a position where a virtual target ring corresponding to the second live-streaming window is located. The virtual target ring is located outside the second live-streaming window, which is not limited in the embodiments of the present disclosure. Correspondingly, the terminal displays at least one virtual target ring of the second live-streaming window, each virtual target ring corresponding to a score. In the case that the interactive prop touches the virtual target ring, the terminal updates and displays the score of the first anchor object based on the score of the virtual target ring. According to the solutions provided in the embodiments of the present disclosure, the first anchor object can control the interactive prop to move to the virtual target ring of the second live-streaming window based on a body action, and in the case that the interactive prop touches the virtual target ring, it can be regarded as a successful interaction of the first anchor object, and the score of the first anchor object is updated and displayed, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

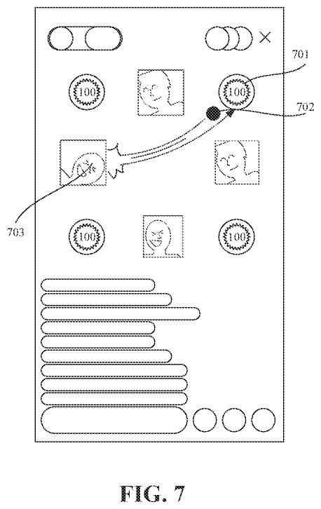

For example, FIG. 7 is a schematic live-streaming page illustrating a fourth interactive special effect according to an exemplary embodiment. Referring to FIG. 7, the terminal displays four virtual target rings 701 and four anchor objects in four live-streaming windows. Each anchor object corresponds to a virtual target ring 701. In the illustrated example, the first anchor object 703 initiates, by a head movement, an action to hit a virtual target ring 701 via an interactive prop 702. In the case that the interactive prop 702 touches the virtual target ring 701, the terminal updates and displays, in the virtual target ring 701, the score of the first anchor object 703 based on the score of the virtual target ring 701. That is, the terminal displays that the score of the first anchor object 703 is increased by 100 points. In other words, each anchor object may “guard” one virtual target ring, and the anchor object may initiate an “attack” against the virtual target rings “guarded” by other anchor objects to win more points.

The scores of different virtual target rings are the same or different, which is not limited in the embodiments of the present disclosure. The score of the virtual target ring of the anchor object is positively correlated with the level of the anchor object, the number of viewer objects in the live-streaming room to which the anchor object belongs, virtual resources such as gifts the anchor object receives, and the number of likes acquired by the anchor object, which is not limited in the embodiments of the present disclosure. The virtual target rings may not have any relationship with the anchor objects, and are independent interactive props for interaction, which are not limited in the embodiments of the present disclosure.

In step 304, the terminal displays the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In the embodiments of the present disclosure, the terminal determines, based on the preset action of the first anchor object, the second anchor object that the first anchor object wants to interact with. Then, the terminal displays the interactive special effect that the interactive element moves from the first live-streaming window to the second live-streaming window indicated by the preset action, and the interactive special effect is formed in the movement process of the interactive element. That is, after the interactive special effect is determined in the step 303, the terminal directly displays the interactive special effect in the step 304. For example, as described in the step 303 above, the interactive special effect is that the expression special effect moves from the face of the first anchor object to the body of the second anchor object in the second live-streaming window, and then the terminal displays the movement process of the expression special effect from the face of the first anchor object to the body of the second anchor object in the second live-streaming window.

In some embodiments, the interactive special effect includes information such as an interactive element, a moving track and a moving speed of the interactive element. Correspondingly, the terminal displays that the interactive element moves at the moving speed along the moving track to present the interactive special effect. The number of interactive elements in the interactive special effect is not limited in the embodiments of the present disclosure.

In some embodiments, the interactive special effect includes a first interactive element and a second interactive element. The first interactive element is configured to represent the interaction progress. The second interactive element is configured to present the interaction mode between the anchor objects. The process that the terminal displays the interactive special effect includes: the terminal displays, for any anchor object, in the case that the first interactive element is in a first form, the movement of the second interactive element from a live-streaming window of the anchor object to another live-streaming window indicated by an action direction of a preset action of the anchor object based on the action direction. The first form is configured to represent that the first interactive element is currently in an interaction state. In the case that an interaction duration reaches a preset duration, the terminal displays that the first interactive element is converted from the first form to a second form, the second form being configured to represent that the first interactive element is currently in an interaction quit state. In the case that the first interactive element is in the second form, the terminal uses an anchor object in a live-streaming window where the second interactive element is currently located as a target object. According to the solutions provided in the embodiments of the present disclosure, the interactive special effect includes a first interactive element and a second interactive element. In the case that the first interactive element is in a first form, a plurality of anchor objects interact within a preset duration, and in the interaction process, the anchor object controls the second interactive element to move to the second live-streaming window based on a preset action to achieve the interaction between the anchor objects. In the case that the interaction duration reaches the preset duration, the interaction is stopped, and the anchor object of the live-streaming window where the second interactive element is currently located is used as the target object, such that the interaction modes between the anchors are enriched, the expressiveness and the interactive effect of the live-streaming rooms are increased, and a more obvious interactive feeling is provided for viewer objects and other anchor objects, which is conducive to improving the interactive atmosphere and retention in the live-streaming room, and attracting more viewer objects to the live-streaming room.

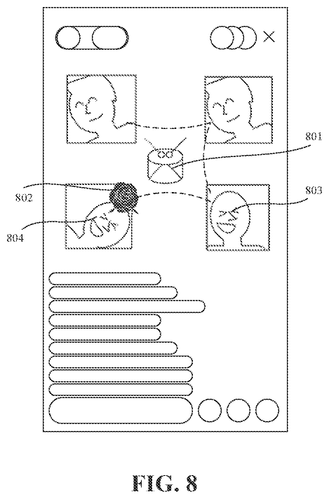

For example, FIG. 8 is a schematic live-streaming page illustrating a fifth interactive special effect according to an exemplary embodiment. Referring to FIG. 8, the first interactive element is a virtual drum 801 having a first form and a second form, the second interactive element is a virtual flower clump 802, the first form is a dynamic state, and the second form is a static state. In the case that the virtual drum 801 is in a dynamic state, the terminal displays, based on an action direction of a head action of the anchor object 803, that the virtual flower clump 802 moves from the live-streaming window of the anchor object 803 to the live-streaming window indicated by the action direction. The virtual flower clump 802 is moving among the plurality of anchor objects (e.g., the four anchor objects). In the case that an interaction duration reaches a preset duration, the terminal displays that the virtual drum 801 is converted from a dynamic state to a static state. In the case that the virtual drum 801 is in a static state, the terminal uses the anchor object 804 of the live-streaming window where the virtual flower clump 802 is currently located as a target object. That is, in the case that the virtual drum 801 is in a drum-beating state, the virtual flower clump 802 can move (transfer) among the anchor objects, forming an interactive special effect of “beat the drum and pass on the flowers”. In the case that the virtual drum 801 stops beating, the terminal uses the anchor object 804 of the live-streaming window where the virtual flower clump 802 is currently located as a target object. The above interaction process is regarded as an interactive game. The target object is considered as a loser or a winner of the game, which is not limited in the embodiments of the present disclosure.

In some embodiments, the first anchor object interacts with an interactive prop to attract viewer objects for the live-streaming room. For example, the interactive prop is an eliminable virtual brick, which is not limited in the embodiments of the present disclosure. Correspondingly, the terminal displays a preset quantity of virtual bricks and the interactive element, and displays, based on an action direction of the preset action of the first anchor object, the movement of the first live-streaming window according to the action direction. In the case that the first live-streaming window touches the interactive element, the terminal displays that the interactive element rebounds from the first live-streaming window. In the case that the interactive element touches the virtual bricks, the terminal displays a disappearing special effect of the virtual bricks. According to the solutions provided in the embodiments of the present disclosure, based on the preset action of the first anchor object, the first live-streaming window of the first anchor object is controlled to move to touch the interactive element, and then the interactive element rebounds from the first live-streaming window to touch the virtual bricks, and the interaction between the anchor object and the virtual bricks is achieved, such that the live-streaming gameplay of a single anchor object is enriched, the expressiveness and the interactive effect of the live-streaming room are increased, and a more obvious interactive feeling is provided for viewer objects, which is conducive to improving the interactive atmosphere and retention in the live-streaming room, and attracting more viewer objects to the live-streaming room.

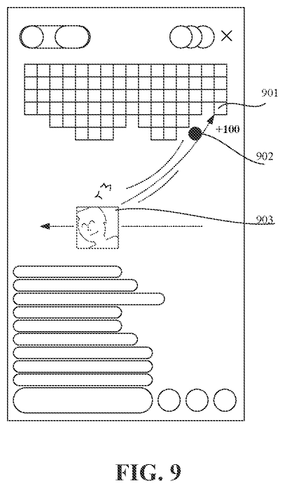

In the case where there is only the first anchor object, the first anchor object may interact with the interactive prop in the above mode. For example, FIG. 9 is a schematic live-streaming page illustrating a sixth interactive special effect according to an exemplary embodiment. Referring to FIG. 9, the terminal displays a preset quantity of virtual bricks 901 and an interactive element 902 (a ball for example). The terminal displays, based on an action direction of a preset action of the first anchor object, the movement of the first live-streaming window 903 according to the action direction. In the case that the first live-streaming window 903 touches the interactive element 902, the terminal displays that the interactive element 902 rebounds from the first live-streaming window 903. In the case that the interactive element 902 touches the virtual bricks 901, the terminal displays a disappearing special effect of the virtual bricks 901. The disappearing special effect is an explosion special effect, which is not limited in the embodiments of the present disclosure. The terminal further displays the score won by the first anchor object as 100 points.

In some embodiments, the live-streaming room has a first anchor object and at least one second anchor object, the first anchor object and the at least one second anchor object interact with the interactive prop in the above mode. That is, the first anchor object and the at least one second anchor object jointly eliminate the virtual bricks. In the process of eliminating the virtual bricks, the first anchor object and the at least one second anchor object jointly transfer the interactive prop, such that the interactive prop can touch the virtual bricks. The effect of “multi-pass shooting” is formed in the interaction process. For example, in the case that the first live-streaming window touches the interactive element, the terminal displays that the interactive element rebounds from the first live-streaming window. In the case that the interactive element touches the second live-streaming window, the terminal displays that the interactive element rebounds from the second live-streaming window. Until the interactive element touches the virtual bricks, the terminal displays the disappearing special effect of the virtual bricks.

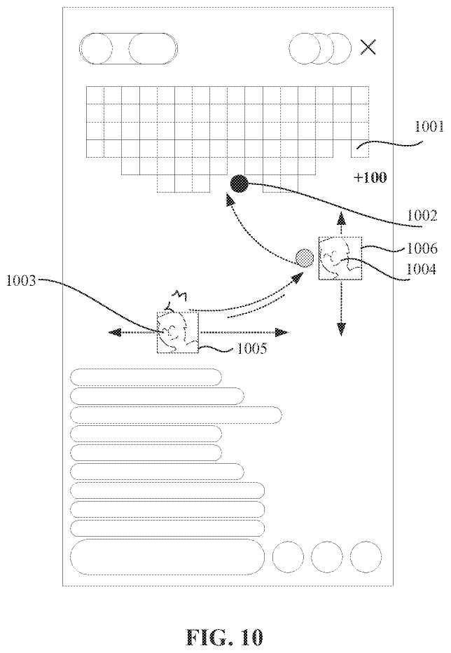

FIG. 10 is a schematic live-streaming page illustrating a seventh interactive special effect according to an exemplary embodiment. Referring to FIG. 10, the terminal displays a preset quantity of virtual bricks 1001, an interactive element 1002 (a ball in this example), a first live-streaming window 1005, and a second live-streaming window 1006. The first live-streaming window 1005 slides in a horizontal direction. The second live-streaming window 1005 slides in a vertical direction. In the illustrated process, the terminal displays, first based on a first action direction of a preset action of the first anchor object 1003, the movement of the first live-streaming window 1005 according to the first action direction (e.g., a horizontal direction). Then, in the case that the first live-streaming window 1005 touches the interactive element 1002, the terminal displays that the interactive element 1002 rebounds from the first live-streaming window 1005 toward the second live-streaming window 1006. Next, the terminal displays, based on a second action direction of a preset action of the second anchor object 1004, the movement of the second live-streaming window 1006 according to the second action direction (e.g., a vertical direction). Next, in the case that the interactive element 1002 touches the second live-streaming window 1006, the terminal displays that the interactive element 1002 rebounds from the second live-streaming window 1006 toward the virtual blocks 1001. Next, in the case that the interactive element 1002 touches the virtual bricks 1001, the terminal displays a disappearing special effect of the virtual bricks 1001. The disappearing special effect is an explosion special effect, which is not limited in the embodiments of the present disclosure. The terminal may also display that the first anchor object and the second anchor object have jointly earned a score of 100 points.

In the embodiments of the present disclosure, the first anchor object interacts with the second anchor object via an interactive special effect. The terminal adds the data of the interactive special effect to the live streaming data stream to push the stream to the terminals of all the second anchor objects currently participating in the interaction and the terminals of all viewer objects in the live-streaming rooms, and thus the terminals of other second anchor objects and the terminals of viewer objects in the live-streaming rooms can all display the interactive special effect. The terminal adds the data of the interactive special effect to video frames in an SEI mode. Then, the viewer side receives the data of the interactive special effect carried in the video frames, and the data is synchronously played on the viewer side.

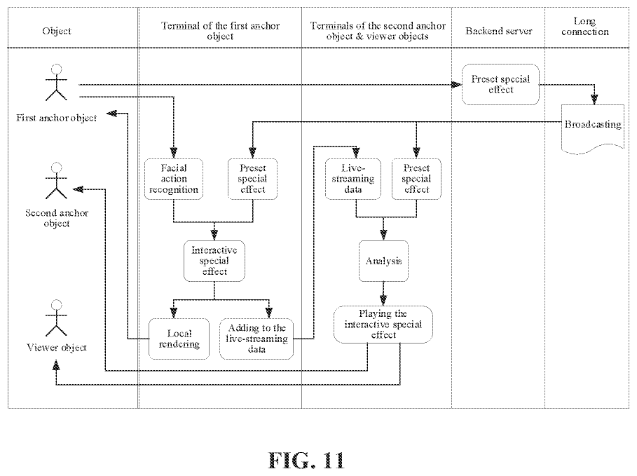

To more clearly describe the method for interacting based on a facial expression of an anchor object, the method is further described below with reference to the accompanying drawing. FIG. 11 is a flowchart illustrating an interaction based on a facial expression of an anchor object according to an exemplary embodiment. The interactions among a first anchor object, a second anchor object, view objects, a terminal of the first anchor object, a terminal of the second anchor object, the terminals of viewer object, a backend server, and long connection are illustrated. In the field of live streaming, the long connection is a connection that a client creates with a server when it initiates a data transfer request, which is not closed even after the data transfer has ended, and continues to provide service for subsequent data transfer requests. The long connection is disconnected if no data transfer request is initiated within a preset period of time. The long connection in FIG. 11 is a connection between the backend server and the terminal of the anchor object or the viewer object. Referring to FIG. 11, the first anchor object selects any of the preset special effects before making a facial expression. Correspondingly, the terminal acquires, in response to a special effect selection operation of the first anchor object, the selected preset special effect from a backend server configured to manage the special effect. Then, the backend server sends, based on the selected preset special effect, broadcast signaling to the terminal of the first anchor object, the terminal of the second anchor object participating in interaction and the terminals of the viewer objects. The broadcast signaling indicates a preset special effect selected by the first anchor object. Then, in the case that the facial expression of the first anchor object appears, the terminal of the first anchor object recognizes the facial expression of the first anchor object to acquire the action content and the action direction of the first anchor object. Then, the terminal of the first anchor object determines the interactive special effect based on the action content and the action direction of the facial expression and the preset special effect. Then, the terminal of the first anchor object renders the interactive special effect locally. Rendering the interactive special effect locally means that the process of rendering interactive special effect is done on that terminal, rather than uploading them to a cloud server for rendering. And, the terminal of the first anchor object adds the data of the interactive special effect to the live-streaming data stream to push the stream to the terminals of all the second anchor objects currently participating in the interaction and the terminals of all viewer objects in the live-streaming rooms. Then, the terminals of the second anchor objects and the terminals of the viewer objects receive the data of the interactive special effect carried in the video frames, and the data is synchronously played on the viewer side.

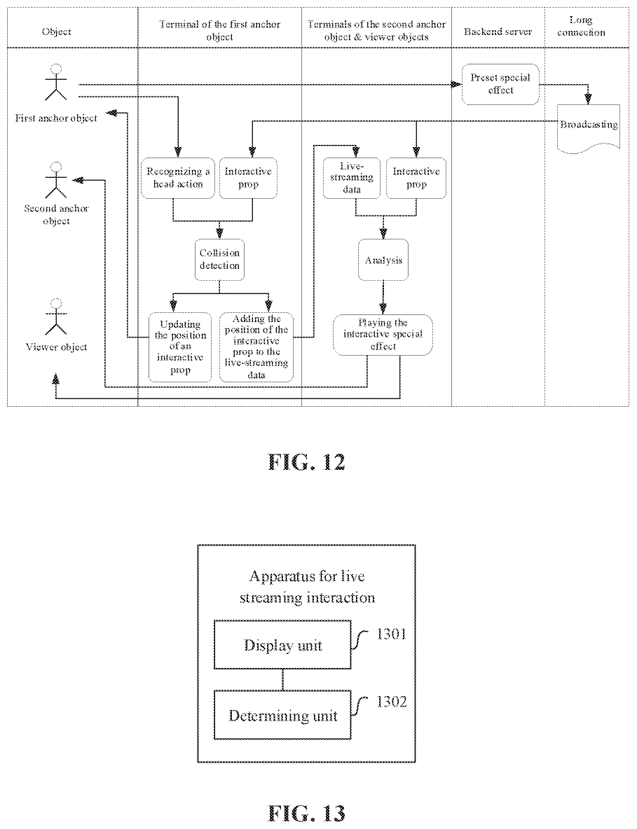

To more clearly describe the method for interacting based on an interactive prop, the method is further described with reference to the accompanying drawing. FIG. 12 is a flowchart illustrating interaction based on an interactive prop according to an exemplary embodiment. The interactions among a first anchor object, a second anchor object, view objects, a terminal of the first anchor object, terminal of the second anchor object, the terminals of viewer object, a backend server, and long connection are illustrated. Referring to FIG. 12, the first anchor object selects an interactive prop before making a head action. Correspondingly, the terminal of the first anchor object acquires, in response to a prop selection operation of the first anchor object, the selected interactive prop from a backend server configured to manage the interactive prop. Then, the backend server sends, based on the selected interactive prop, broadcast signaling to the terminal of the first anchor object, the terminal of the second anchor object participating in interaction and the terminals of the viewer objects. The broadcast signaling indicates an interactive prop selected by the first anchor object. Then, the terminal of the first anchor object determines the initial position of the interactive prop and collision detection frames. The collision detection frames are the boundary of the interactive prop, the frame of the live-streaming window, and the frame of the virtual target ring. Then, the terminal of the first anchor object detects whether the interactive prop collides with the frame of the first live-streaming window. In the case that the interactive prop touches the frame of the first live-streaming window, the terminal of the first anchor object recognizes the head action of the first anchor object to acquire the action content and the action direction of the first anchor object. Then, the terminal of the first anchor object determines the moving track of the interactive prop based on the action content and the action direction of the head action. The interactive prop moves along the moving track to form an interactive special effect. The terminal of the first anchor object renders the interactive special effect locally. That is, the terminal of the first anchor object updates the position of the interactive prop. And, the terminal adds the position of the interactive prop to the live-streaming data stream to push the stream to the terminals of all the second anchor objects currently participating in the interaction and the terminals of all viewer objects in the live-streaming rooms. Then, the terminals of the second anchor objects and the terminals of the viewer objects receive the position of the interactive prop carried in the video frames, and the position is synchronously played on the viewer side.

In some embodiments, a method for live streaming interaction, is provided. The method is performed by a terminal of a first anchor object in a live-streaming room, and includes: displaying, on a live-streaming page, the first anchor object in a first live-streaming window and a second anchor object in a second live-streaming window; in a case that the first anchor object in the first live-streaming window makes a preset action, recognizing the preset action; and acquiring an action content and an action direction, wherein the preset action is a body action; determining an interactive special effect associated with the preset action based on the action content and the action direction, wherein the interactive special effect comprising an interactive element; rendering the interactive special effect locally in the terminal; adding data of the interactive special effect to a live-streaming data stream to push the live-streaming data stream to a terminal of the second anchor object and terminals of all viewer objects in the live-streaming rooms such that the terminal of the second anchor object and the terminals of all viewer objects in the live-streaming rooms are capable of displaying the interactive special effect; and displaying the interactive special effect, wherein the interactive special effect is a movement of the interactive element from the first live-streaming window to the second live-streaming window.

In some embodiments, recognizing the preset action; and acquiring an action content and an action direction comprising: capturing the body action of the first anchor object; in a case that the body action is a facial expression or a head action, recognizing a key point in a face of the first anchor object through a facial action recognition system to determine an action track of the key point in the face of the first anchor object to acquire the head action of the first anchor object and the action direction indicated by the head action; in a case that the body action is a limb action or a torso action, recognizing a key point in a limb or a torso of the first anchor object through a human body recognition system to determine an action track of the key point in the limb or the torso of the first anchor object to acquire the limb action or the torso action of the first anchor object and the action direction indicated by the limb action or the torso action.

According to the solutions provided in the embodiments of the present disclosure, an action of an anchor object in a live-streaming window can be captured in the interaction process of a plurality of anchor objects, an interactive special effect triggered by a preset action can be determined when the anchor object makes the preset action, and then the movement of an interactive element in the interactive special effect from the live-streaming window where the anchor object is located to other live-streaming windows where other anchor objects are located is displayed, so as to present the interactive special effect between the anchor object and other anchor objects. An anchor object does not need to select an interaction mode each time for interaction, and can achieve the interaction with other anchor objects only by making a preset action, such that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

All the above optional technical solutions may be combined in any way to form some embodiments of the present disclosure, which are thus not repeated herein.

FIG. 13 is a block diagram illustrating an apparatus for live streaming interaction according to an exemplary embodiment. Referring to FIG. 13, the apparatus for live streaming interaction includes a display unit 1301 and a determining unit 1302.

The display unit 1301 is configured to display a first anchor object in a first live-streaming window and a second anchor object in a second live-streaming window;
the determining unit 1302 is configured to determine, in the case that the first anchor object in the first live-streaming window makes a preset action, an interactive special effect associated with the preset action, the interactive special effect including an interactive element; and
the display unit 1301 is further configured to display the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

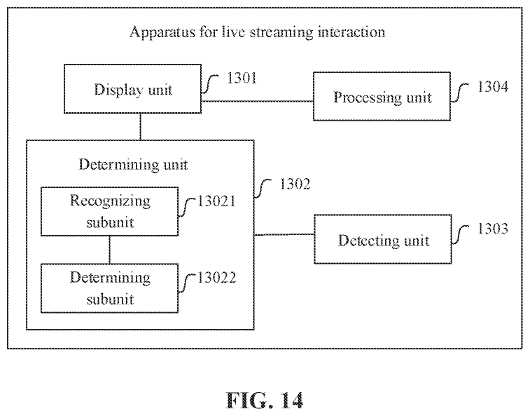

In some embodiments, FIG. 14 is a block diagram illustrating another apparatus for live streaming interaction according to an exemplary embodiment. Referring to FIG. 14, the determining unit 1302 includes:
a recognizing subunit 13021, configured to acquire, in the case that the first anchor object in the first live-streaming window makes a preset action, an action content and an action direction of the first anchor object by recognizing the preset action of the first anchor object; and
a determining subunit 13022, configured to determine the interactive special effect based on the action content and at least one of the action direction or a preset special effect.

In some embodiments, the action direction is to indicate the second live-streaming window; and the determining subunit 13022 is configured to determine the interactive special effect based on the action direction, the interactive special effect being that the interactive element moves from the first live-streaming window to the second live-streaming window indicated by the action direction.

In some embodiments, referring to FIG. 14, the action content is a body action of the first anchor object, the limb action including at least one of a facial expression, a head action, a limb action, or a torso action, and the preset special effect is a body special effect; and the determining subunit 13022 is configured to determine the interactive special effect based on the body action of the first anchor object and the body special effect.

In some embodiments, referring to FIG. 14, the body action is a facial expression of the first anchor object, and the body special effect is an expression special effect; and the determining subunit 13022 is configured to determine the interactive special effect based on the facial expression of the first anchor object and the expression special effect.

In some embodiments, referring to FIG. 14, the determining subunit 13022 is configured to generate, based on the facial expression of the first anchor object and the expression special effect, an interactive special effect including the interactive element, the interactive element being a facial part of the first anchor object, and the interactive special effect being that the facial part of the first anchor object moves from the face of the first anchor object to a body of the second anchor object in the second live-streaming window.

In some embodiments, referring to FIG. 14, the determining subunit 13022 is configured to use an expression special effect corresponding to the facial expression of the first anchor object as an interactive element in the interactive special effect, the interactive special effect being that the expression special effect moves from a face of the first anchor object to a body of the second anchor object in the second live-streaming window.

In some embodiments, referring to FIG. 14, the action content is a body action of the first anchor object, the body action including at least one of a facial expression, a head action, a limb action, or a torso action, and the preset special effect is a body special effect, the body special effect being a movement process of an interactive prop; and
the determining subunit 13022 is configured to determine, in the case that the interactive prop touches the first live-streaming window, a moving track of the interactive prop based on an action direction of the body action; and determine the interactive special effect based on the moving track, the interactive special effect being that the interactive prop starts from the first live-streaming window and moves to a target position of the second live-streaming window along the moving track.

In some embodiments, referring to FIG. 14, the target position of the second live-streaming window is a position where a boundary of the second live-streaming window is located, and the display unit is further configured to update and display a score of the first anchor object in the case that the interactive prop touches the boundary of the second live-streaming window; and
the display unit 1301 is further configured to update and display, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, referring to FIG. 14, the target position of the second live-streaming window is a position where a virtual target ring of the second live-streaming window is located; and the display unit 1301 is further configured to display at least one virtual target ring of the second live-streaming window, each virtual target ring corresponding to a score, and update and display, in the case that the interactive prop touches the virtual target ring, the score of the anchor object based on the score of the virtual target ring.

In some embodiments, referring to FIG. 14, the apparatus further includes:
a detecting unit 1303, configured to detect a boundary of the first live-streaming window based on a position of the first live-streaming window; and determine, in the case that a boundary of the interactive prop overlaps the boundary of the first live-streaming window, that the interactive prop touches the first live-streaming window.

In some embodiments, referring to FIG. 14, the apparatus further includes a processing unit 1304 configured to determine, in the case that the interactive prop touches the first live-streaming window, a moving speed of the interactive prop based on an action parameter of the body action and an elastic parameter of the interactive prop;
the processing unit 1304 is further configured to determine, based on a boundary of the interactive prop and a boundary of the first live-streaming window, a collision position of the interactive prop with the first live-streaming window; and
the determining unit 1302 is configured to determine the interactive special effect based on the moving track, the moving speed, and the collision position, the interactive special effect being that the interactive prop starts from the collision position and moves to the target position of the second live-streaming window at the moving speed along the moving track.

In some embodiments, referring to FIG. 14, the interactive special effect includes a first interactive element and a second interactive element, the first interactive element being configured to represent the interaction progress, and the second interactive element being configured to present an interaction mode between anchor objects; and
the display unit 1301 is further configured to display, for any anchor object, in the case that the first interactive element is in a first form, the movement of the second interactive element from a live-streaming window of the anchor object to a live-streaming window indicated by an action direction of a preset action of the anchor object based on the action direction, the first form being configured to represent that the first interactive element is currently in an interaction state; display, in the case that an interaction duration reaches a preset duration, that the first interactive element is converted from the first form to a second form, the second form being configured to represent that the first interactive element is currently in an interaction quit state; and use, in the case that the first interactive element is in the second form, an anchor object in a live-streaming window where the second interactive element is currently located as a target object.

In some embodiments, referring to FIG. 14, the display unit 1301 is further configured to display a preset quantity of virtual bricks and the interactive element; display, based on an action direction of the preset action of the first anchor object, a movement of the first live-streaming window according to the action direction; display, in the case that the first live-streaming window touches the interactive element, that the interactive element rebounds from the first live-streaming window; and display, in the case that the interactive element touches the virtual bricks, a disappearing special effect of the virtual bricks.

In some embodiments, referring to FIG. 14, the display unit 1301 is further configured to display, in the case that the interactive element touches the second live-streaming window, that the interactive element rebounds from the second live-streaming window.

According to the apparatus for live streaming interaction provided in the embodiments of the present disclosure, an action of an anchor object in a live-streaming window can be captured in the interaction process of a plurality of anchor objects, an interactive special effect triggered by a preset action can be determined when the anchor object makes the preset action, and then the movement of an interactive element in the interactive special effect from the live-streaming window where the anchor object is located to other live-streaming windows where other anchor objects are located is displayed, so as to present the interactive special effect between the anchor object and indicated anchor objects. An anchor object does not need to select an interaction mode each time for interaction, and can achieve the interaction with other anchor objects only by making a preset action, so that the method is simple to operate, and can improve the interaction efficiency; and also, the method enriches the interaction modes among the anchors, increases the expressiveness and the interactive effect of the live-streaming rooms, and gives viewer objects and other anchor objects a more obvious interactive feeling, which is conducive to improving the interactive atmosphere and retention in the live-streaming room, and attracting more viewer objects to the live-streaming room.

It should be noted that, in the process of multi-player live streaming, the apparatus for live streaming interaction according to the above embodiments only illustrates the division of the functional units. In practice, the above functions can be assigned to different functional units as needed, that is, the internal structure of the electronic device may be divided into different functional units, so as to implement all or a part of the above functions. In addition, the apparatus for live streaming interaction and the method for live streaming interaction according to the above embodiments belong to the same concept, and specific implementation processes thereof are described in the method embodiments in detail, and are not repeated herein.

With regard to the apparatus in the above embodiments, the specific manner in which each module performs the operation has been described in detail in the embodiments related to the method, and will not be described in detail herein.

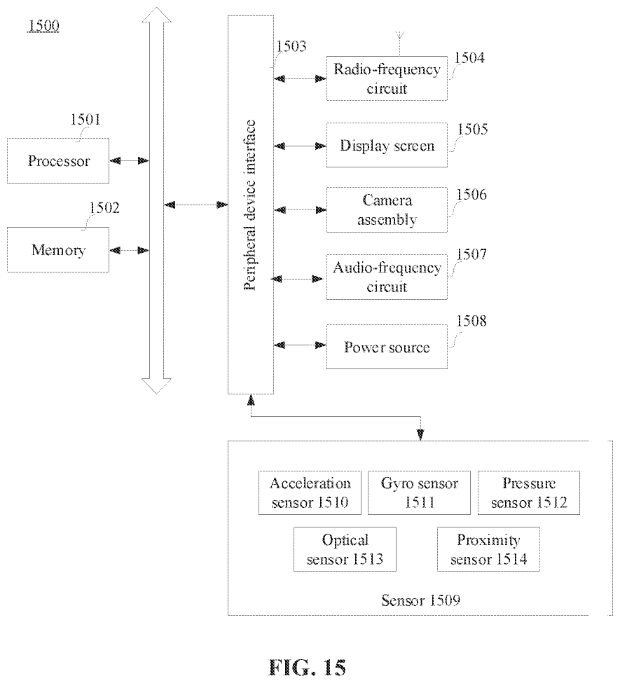

In the case that the electronic device is provided as a terminal, FIG. 15 is a block diagram illustrating a terminal 1500 according to an exemplary embodiment. The terminal 1500 may be a smart phone, a tablet computer, a moving picture experts group audio layer III (MP3) player, a moving picture experts group audio layer IV (MP4) player, a notebook computer, or a desktop computer. The terminal 1500 is also referred to as user equipment, a portable terminal, a laptop terminal, a desktop terminal, or the like.

Generally, the terminal 1500 includes: a processor 1501 and a memory 1502.

The processor 1501 includes one or more processing cores, such as a 4-core processor and an 8-core processor. The processor 1501 is implemented in at least one hardware form of a digital signal processor (DSP), a field-programmable gate array (FPGA), and a programmable logic array (PLA). The processor 1501 further includes a main processor and a coprocessor. The main processor is a processor configured to process data in an awake state, and is also referred to as a central processing unit (CPU). The coprocessor is a low-power processor configured to process data in a standby state. In some embodiments, the processor 1501 is integrated with a graphics processing unit (GPU) that is responsible for rendering and drawing contents that need to be displayed on a display screen. In some embodiments, the processor 1501 further includes an artificial intelligence (AI) processor for processing computing operations related to machine learning.

The memory 1502 includes one or more computer-readable storage media, which is non-transitory. The memory 1502 further includes a high-speed random access memory, and a non-volatile memory, such as one or more magnetic disk storage devices and flash storage devices. In some embodiments, the non-transitory computer-readable storage medium in the memory 1502 is configured to store at least one program code, wherein the at least one program code is configured to, when executed by the processor 1501, cause the electronic device to perform the method for live streaming interaction according to the method embodiments of the present disclosure.

In some embodiments, the terminal 1500 further optionally includes: a peripheral device interface 1503 and at least one peripheral device. The processor 1501, the memory 1502, and the peripheral device interface 1503 are connected via buses or signal lines. The peripheral devices are connected to the peripheral device interface 1503 via a bus, signal line, or circuit board. Specifically, the peripheral devices include: at least one of a radio-frequency circuit 1504, a display screen 1505, a camera assembly 1506, an audio-frequency circuit 1507, and a power source 1508.

The peripheral device interface 1503 is configured to connect at least one peripheral device related to input/output (I/O) to the processor 1501 and the memory 1502. In some embodiments, the processor 1501, the memory 1502, and the peripheral device interface 1503 are integrated on the same chip or circuit board; and in some other embodiments, any one or two of the processor 1501, the memory 1502, and the peripheral device interface 1503 are implemented on a separate chip or circuit board.

The peripheral device interface 1503 is configured to connect at least one peripheral device related to input/output (I/O) to the processor 1501 and the memory 1502. In some embodiments, the processor 1501, the memory 1502, and the peripheral device interface 1503 are integrated on the same chip or circuit board. In some other embodiments, any one or two of the processor 1501, the memory 1502, and the peripheral device interface 1503 are implemented on a separate chip or circuit board, which is not limited in the embodiments.

The radio-frequency circuit 1504 is configured to receive and transmit a radio frequency (RF) signal, which is also referred to as an electromagnetic signal. The radio-frequency circuit 1504 communicates with a communication network and other communication devices via electromagnetic signals. The radio-frequency circuit 1504 converts an electrical signal into an electromagnetic signal for transmission, or converts a received electromagnetic signal into an electrical signal. In some embodiments, the radio-frequency circuit 1504 includes an antenna system, an RF transceiver, one or more amplifiers, a tuner, an oscillator, a digital signal processor, a codec chipset, a subscriber identity module card, and the like. The radio-frequency circuit 1504 communicates with other terminals via at least one wireless communication protocol. The wireless communication protocol includes, but is not limited to, the World Wide Web, a metropolitan area network, an intranet, generations of mobile communication networks (2G, 3G, 4G, and 5G), a wireless local area network and/or a wireless fidelity (Wi-Fi) network. In some embodiments, the radio-frequency circuit 1504 further includes a near field communication (NFC) related circuit, which is not limited in the present disclosure.

The display screen 1505 is configured to display a user interface (UI). The UI includes graphics, text, icons, videos, and any combination thereof. In the case that the display screen 1505 is a touch display screen, the display screen 1505 also has the capacity to acquire a touch signal on or above a surface of the display screen 1505. The touch signal is input to the processor 1501 as a control signal for processing. In this case, the display screen 1505 is also configured to provide virtual buttons and/or virtual keyboards, which are also referred to as soft buttons and/or soft keyboards. In some embodiments, there is one display screen 1505 arranged on a front panel of the terminal 1500. In some other embodiments, there are at least two display screens 1505 arranged on different surfaces of the terminal 1500, respectively, or in a folded design. In some still other embodiments, the display screen 1505 is a flexible display screen arranged on a curved surface or a folded surface of the terminal 1500. The display screen 1505 is even set to a non-rectangular irregular pattern, that is, a special-shaped screen. The display screen 1505 is prepared by using a material such as a liquid crystal display (LCD) or an organic light-emitting diode (OLED).

The camera assembly 1506 is configured to capture images or videos. In some embodiments, the camera assembly 1506 includes a front camera and a rear camera. Generally, the front camera is disposed on the front panel of the terminal, and the rear camera is disposed on a back side of the terminal. In some embodiments, there are at least two rear cameras, which are any one of a primary camera, a depth of field camera, a wide-angle camera, and a telephoto camera, such that the primary camera and the depth of field camera are combined to implement a bokeh function, the primary camera and the wide-angle camera are combined to implement panoramic shooting and virtual reality (VR) shooting functions, or other combined shooting functions are implemented. In some embodiments, the camera assembly 1506 further includes a flash. The flash is a single-color temperature flash or a two-color temperature flash. The two-color temperature flash is a combination of a warm-light flash and a cold-light flash, and is employed for light compensation at different color temperatures.

The audio-frequency circuit 1507 includes a microphone and a speaker. The microphone is configured to acquire sound waves from users and the environments, and convert the sound waves into electrical signals, which are then input to the processor 1501 to be processed, or input to the radio-frequency circuit 1504 for voice communication. For stereo acquisition or noise reduction, there are a plurality of microphones disposed at different parts of the terminal 1500. The microphone is also an array microphone or an omnidirectional acquisition microphone. The speaker is configured to convert the electrical signal from the processor 1501 or the radio-frequency circuit 1504 into sound waves. The speaker is a traditional film speaker or a piezoelectric ceramic speaker. In the case that the speaker is a piezoelectric ceramic speaker, the electric signals may be converted into sound waves not only human-audible sound waves, but also the sound waves which are inaudible to human beings for distance measurement and the like. In some embodiments, the audio-frequency circuit 1507 further includes a headphone jack.

The power source 1508 is configured to supply power for various components in the terminal 1500. The power source 1508 is an alternating current, a direct current, a disposable battery, or a rechargeable battery. In the case that the power source 1508 includes a rechargeable battery, the rechargeable battery is a wired rechargeable battery or a wireless rechargeable battery. The wired rechargeable battery is a battery charged by a wired line, and the wireless rechargeable battery is a battery charged by a wireless coil. The rechargeable battery is also configured to support fast charging.

In some embodiments, the terminal 1500 further includes one or more sensors 1509. The one or more sensors 1509 include, but are not limited to, an acceleration sensor 1510, a gyro sensor 1511, a pressure sensor 1512, an optical sensor 1513, and a proximity sensor 1514.

The acceleration sensor 1510 is configured to detect magnitudes of accelerations on three coordinate axes of a coordinate system established by the terminal 1500. For example, the acceleration sensor 1510 is configured to detect components of a gravitational acceleration on the three coordinate axes. The processor 1501 controls, according to a gravity acceleration signal acquired by the acceleration sensor 1510, the display screen 1505 to display a user interface in a landscape view or a portrait view. The acceleration sensor 1510 is further configured to acquire game data or motion data of the user.

The gyro sensor 1511 is configured to detect a body direction and a rotation angle of the terminal 1500. The gyro sensor 1511 cooperates with the acceleration sensor 1510 to acquire a 3D motion of the user to the terminal 1500. Based on the data acquired by the gyro sensor 1511, the processor 1501 implements the following functions: motion sensing (for example, changing the UI according to a tilting operation of the user), image stabilization during shooting, game control, and inertial navigation.

The pressure sensor 1512 is disposed on a side frame of the terminal 1500 and/or a lower layer of the display screen 1505. In the case that the pressure sensor 1512 is disposed on the side frame of the terminal 1500, a holding signal of the user to the terminal 1500 can be detected, and the processor 1501 performs left-right hand identification or quick operation based on the holding signal acquired by the pressure sensor 1512. In the case that the pressure sensor 1512 is disposed on the lower layer of the display screen 1505, an operable control on the UI is controlled through the processor 1501 based on the pressure operation of the user on the display screen 1505. The operable control includes at least one of a button control, a scroll bar control, an icon control, and a menu control.

The optical sensor 1513 is configured to acquire ambient light intensity. In some embodiments, the processor 1501 controls the display brightness of the display screen 1505 based on the ambient light intensity acquired by the optical sensor 1513. Specifically, in the case that the ambient light intensity is high, the display brightness of the display screen 1505 is increased; in the case that the ambient light intensity is low, the display brightness of the display screen 1505 is decreased. In another embodiment, the processor 1501 also dynamically adjusts shooting parameters of the camera assembly 1506 based on the ambient light intensity acquired by the optical sensor 1513.

The proximity sensor 1514, also known as a distance sensor, is usually disposed on the front panel of the terminal 1500. The proximity sensor 1514 is configured to acquire a distance between the user and the front side of the terminal 1500. In some embodiments, in the case that the proximity sensor 1514 detects that the distance between the user and the front side of the terminal 1500 is gradually decreasing, the processor 1501 controls the display screen 1505 to switch from a screen-on state to a screen-off state; and in the case that the proximity sensor 1514 detects that the distance between the user and the front side of the terminal 1500 is gradually increasing, the processor 1501 controls the display screen 1505 to switch from the screen-off state to the screen-on state.

Those skilled in the art will understand that the structure illustrated in FIG. 15 does not constitute limitation of the terminal 1500, and that more or fewer components than those illustrated are included, or some of the components are combined, or a different arrangement of components is employed.

The embodiments of the present disclosure further provide an electronic device. The electronic device includes: one or more processors;
a memory configured to store one or more program codes executable by the one or more processors,
wherein the one or more processors, when loading and executing the one or more program codes, are caused to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In some embodiments, the one or more processors, when loading and executing the one or more program codes, are caused to perform:
acquiring, in the case that the first anchor object in the first live-streaming window makes the preset action, an action content and an action direction by recognizing the preset action; and
determining the interactive special effect based on the action content and at least one of the action direction or a preset special effect.

In some embodiments, the action direction is to indicate the second live-streaming window; and the one or more processors, when loading and executing the one or more program codes, are caused to perform:
determining the interactive special effect based on the action direction, the interactive special effect being that the interactive element moves from the first live-streaming window to the second live-streaming window indicated by the action direction.

In some embodiments, the action content is a body action of the first anchor object, the body action includes at least one of a facial expression, a head action, a limb action, or a torso action, and the preset special effect is a body special effect; and the one or more processors, when loading and executing the one or more program codes, are caused to perform:
determining the interactive special effect based on the body action of the first anchor object and the body special effect.

In some embodiments, the body action is a facial expression of the first anchor object, and the body special effect is an expression special effect; and the one or more processors, when loading and executing the one or more program codes, are caused to perform:
determining the interactive special effect based on the facial expression of the first anchor object and the expression special effect.

In some embodiments, the one or more processors, when loading and executing the one or more program codes, are caused to perform:
generating, based on the facial expression of the first anchor object and the expression special effect, an interactive special effect including the interactive element, the interactive element being a facial part of the first anchor object, and the interactive special effect being that the facial part of the first anchor object moves from the face of the first anchor object to the body of the second anchor object in the second live-streaming window.

In some embodiments, the one or more processors, when loading and executing the one or more program codes, are caused to perform:
using an expression special effect corresponding to the facial expression of the first anchor object as an interactive element in the interactive special effect, the interactive special effect being that the expression special effect moves from the face of the first anchor object to the body of the second anchor object in the second live-streaming window.

In some embodiments, the action content is a body action of the first anchor object, the body action including at least one of a facial expression, a head action, a limb action, or a body action, and the preset special effect is a body special effect, the body special effect being a movement process of an interactive prop; and the one or more processors, when loading and executing the one or more program codes, are caused to perform:
determining, in the case that the interactive prop touches the first live-streaming window, a moving track of the interactive prop based on the action direction of the body action; and
determining the interactive special effect based on the moving track, the interactive special effect being that the interactive prop starts from the first live-streaming window and moves to a target position of the second live-streaming window along the moving track.

In some embodiments, the target position of the second live-streaming window is a position where a boundary of the second live-streaming window is located, and the one or more processors, when loading and executing the one or more program codes, are caused to perform:
updating and displaying a score of the first anchor object in the case that the interactive prop touches the boundary of the second live-streaming window; and
updating and displaying, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, the target position of the second live-streaming window is a position where a virtual target ring of the second live-streaming window is located; and the one or more processors, when loading and executing the one or more program codes, are caused to perform:
displaying at least one virtual target ring of the second live-streaming window, each virtual target ring corresponding to a score; and
updating and displaying, in the case that the interactive prop touches the virtual target ring, a score of the first anchor object based on a score of the virtual target ring.

In some embodiments, the one or more processors, when loading and executing the one or more program codes, are caused to perform:
detecting a boundary of the first live-streaming window based on a position of the first live-streaming window; and
determining, in the case that a boundary of the interactive prop overlaps the boundary of the first live-streaming window, that the interactive prop touches the first live-streaming window.

In some embodiments, the one or more processors, when loading and executing the one or more program codes, are caused to perform:
determining, in the case that the interactive prop touches the first live-streaming window, a moving speed of the interactive prop based on an action parameter of the body action and an elastic parameter of the interactive prop; and
determining, based on a boundary of the interactive prop and a boundary of the first live-streaming window, a collision position of the interactive prop with the first live-streaming window; and
determining the interactive special effect based on the moving track, the moving speed, and the collision position, the interactive special effect being that the interactive prop starts from the collision position and moves to the target position of the second live-streaming window at the moving speed along the moving track.

In some embodiments, the interactive special effect includes a first interactive element and a second interactive element, the first interactive element being configured to represent interaction progress, and the second interactive element being configured to present an interaction mode between anchor objects; and the one or more processors, when loading and executing the one or more program codes, are caused to perform:
displaying, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in the case that an interaction duration reaches a preset duration, that the first interactive element is converted from the first form to a second form, the second form being configured to represent that the first interactive element is currently in an interaction quit state; and
using, in the case that the first interactive element is in the second form, an anchor object in a live-streaming window where the second interactive element is currently located as a target object.

In some embodiments, the one or more processors, when loading and executing the one or more program codes, are caused to perform:
displaying a preset quantity of virtual bricks and the interactive element;
displaying, based on an action direction of the preset action of the first anchor object, a movement of the first live-streaming window according to the action direction;
displaying, in the case that the first live-streaming window touches the interactive element, that the interactive element rebounds from the first live-streaming window; and
displaying, in the case that the interactive element touches the virtual bricks, a disappearing special effect of the virtual bricks.

In some embodiments, the one or more processors, when loading and executing the one or more program codes, are caused to perform:
displaying, in the case that the interactive element touches the second live-streaming window, that the interactive element rebounds from the second live-streaming window.

In some embodiments, further provided is a computer-readable storage medium storing at least one instruction, such as the memory 1502 storing at least one instruction. The at least one instruction, when executed by the processor 1501 of the terminal 1500, causes the electronic device to perform the method for live streaming interaction described above. Optionally, the computer-readable storage medium is a read-only memory (ROM), a random access memory (RAM), a compact disc read-only memory (CD-ROM), a magnetic tape, a floppy disk, an optical data storage device, or the like.

The embodiments of the present disclosure further provide a computer-readable storage medium storing at least one instruction therein. The at least one instruction, when executed by a processor of an electronic device, causes the electronic device to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In some embodiments, the at least one instruction, when executed by the processor of the electronic device, causes the electronic device to perform:
acquiring, in the case that the first anchor object in the first live-streaming window makes the preset action, an action content and an action direction by recognizing the preset action; and
determining the interactive special effect based on the action content and at least one of the action direction or a preset special effect.

In some embodiments, the action direction is to indicate the second live-streaming window; and the at least one instruction, when executed by the processor of the electronic device, causes the electronic device to perform:
determining the interactive special effect based on the action direction, the interactive special effect being that the interactive element moves from the first live-streaming window to the second live-streaming window indicated by the action direction.

In some embodiments, the action content is a body action of the first anchor object, the body action including at least one of a facial expression, a head action, a limb action, or a torso action, and the preset special effect is a body special effect; and the at least one instruction, when executed by the processor of the electronic device, causes the electronic device to perform:
determining the interactive special effect based on the body action of the first anchor object and the body special effect.

In some embodiments, the body action is a facial expression of the first anchor object, and the body special effect is an expression special effect; and the at least one instruction, when executed by the processor of the electronic device, causes the electronic device to perform:
determining the interactive special effect based on the facial expression of the first anchor object and the expression special effect.

In some embodiments, the at least one instruction, when executed by the processor of the electronic device, causes the electronic device to perform:
generating, based on the facial expression of the first anchor object and the expression special effect, an interactive special effect including the interactive element, the interactive element being a facial part of the first anchor object, and the interactive special effect being that the facial part of the first anchor object moves from a face of the first anchor object to a body of the second anchor object in the second live-streaming window.

In some embodiments, the at least one instruction, when executed by the processor of the electronic device, causes the electronic device to perform:
using an expression special effect corresponding to the facial expression of the first anchor object as an interactive element in the interactive special effect, the interactive special effect being that the expression special effect moves from the face of the first anchor object to the body of the second anchor object in the second live-streaming window.

In some embodiments, the action content is a body action of the first anchor object, the body action including at least one of a facial expression, a head action, a torso action, or a body action, and the preset special effect is a body special effect, the body special effect being a movement process of an interactive prop; and the at least one instruction, when executed by the processor of the electronic device, causes the electronic device to perform:
determining, in the case that the interactive prop touches the first live-streaming window, a moving track of the interactive prop based on an action direction of the body action; and
determining the interactive special effect based on the moving track, the interactive special effect being that the interactive prop starts from the first live-streaming window and moves to a target position of the second live-streaming window along the moving track.

In some embodiments, the target position of the second live-streaming window is a position where a boundary of the second live-streaming window is located, and the at least one instruction, when executed by the processor of the electronic device, causes the electronic device to perform:
updating and displaying a score of the first anchor object in the case that the interactive prop touches the boundary of the second live-streaming window; and
updating and displaying, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, the target position of the second live-streaming window is a position where a virtual target ring of the second live-streaming window is located; and the at least one instruction, when executed by the processor of the electronic device, causes the electronic device to perform:
displaying at least one virtual target ring of the second live-streaming window, each virtual target ring corresponding to a score; and
updating and displaying, in the case that the interactive prop touches the virtual target ring, a score of the first anchor object based on a score of the virtual target ring.

In some embodiments, the at least one instruction, when executed by the processor of the electronic device, causes the electronic device to perform:
detecting a boundary of the first live-streaming window based on a position of the first live-streaming window; and
determining, in the case that a boundary of the interactive prop overlaps the boundary of the first live-streaming window, that the interactive prop touches the first live-streaming window.

In some embodiments, the at least one instruction, when executed by the processor of the electronic device, causes the electronic device to perform:
determining, in the case that the interactive prop touches the first live-streaming window, a moving speed of the interactive prop based on an action parameter of the body action and an elastic parameter of the interactive prop; and
determining, based on a boundary of the interactive prop and a boundary of the first live-streaming window, a collision position of the interactive prop with the first live-streaming window; and
determining the interactive special effect based on the moving track, the moving speed, and the collision position, the interactive special effect being that the interactive prop starts from the collision position and moves to the target position of the second live-streaming window at the moving speed along the moving track.

In some embodiments, the interactive special effect includes a first interactive element and a second interactive element, the first interactive element being configured to represent interaction progress, and the second interactive element being configured to present an interaction mode between anchor objects; and the at least one instruction, when executed by the processor of the electronic device, causes the electronic device to perform:
displaying, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in the case that an interaction duration reaches a preset duration, that the first interactive element is converted from the first form to a second form, the second form being configured to represent that the first interactive element is currently in an interaction quit state; and
using, in the case that the first interactive element is in the second form, an anchor object in a live-streaming window where the second interactive element is currently located as a target object.

In some embodiments, the at least one instruction, when executed by the processor of the electronic device, causes the electronic device to perform:
displaying a preset quantity of virtual bricks and the interactive element;
displaying, based on an action direction of the preset action of the first anchor object, a movement of the first live-streaming window according to the action direction;
displaying, in the case that the first live-streaming window touches the interactive element, that the interactive element rebounds from the first live-streaming window; and
displaying, in the case that the interactive element touches the virtual bricks, a disappearing special effect of the virtual bricks.

In some embodiments, the at least one instruction, when executed by the processor of the electronic device, causes the electronic device to perform:
displaying, in the case that the interactive element touches the second live-streaming window, that the interactive element rebounds from the second live-streaming window.

The embodiments of the present disclosure further provide a computer program product including at least one computer programs/instruction. The at least one computer program/instruction, when executed by a processor of an electronic device, causes the electronic device to perform:
displaying a first anchor object in a first live-streaming window and a second anchor object in a second live-streaming window;
determining, in the case that the first anchor object in the first live-streaming window makes a preset action, an interactive special effect associated with the preset action, the interactive special effect including an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

In some embodiments, at least one computer program/instruction, when executed by the processor of the electronic device, causes the electronic device to perform:
acquiring, in the case that the first anchor object in the first live-streaming window makes the preset action, an action content and an action direction by recognizing the preset action; and
determining the interactive special effect based on the action content and at least one of the action direction or a preset special effect.

In some embodiments, the action direction is to indicate the second live-streaming window; and at least one computer program/instruction, when executed by the processor of the electronic device, causes the electronic device to perform:
determining the interactive special effect based on the action direction, the interactive special effect being that the interactive element moves from the first live-streaming window to the second live-streaming window indicated by the action direction.

In some embodiments, the action content is a body action of the first anchor object, the body action including at least one of a facial expression, a head action, a limb action, or a torso action, and the preset special effect is a body special effect; and at least one computer program/instruction, when executed by the processor of the electronic device, causes the electronic device to perform:
determining the interactive special effect based on the body action of the first anchor object and the body special effect.

In some embodiments, the body action is a facial expression of the first anchor object, and the body special effect is an expression special effect; and at least one computer program/instruction, when executed by the processor of the electronic device, causes the electronic device to perform:
determining the interactive special effect based on the facial expression of the first anchor object and the expression special effect.

In some embodiments, at least one computer program/instruction, when executed by the processor of the electronic device, causes the electronic device to perform:
generating, based on the facial expression of the first anchor object and the expression special effect, an interactive special effect including the interactive element, the interactive element being a facial part of the first anchor object, and the interactive special effect being that the facial part of the first anchor object moves from a face of the first anchor object to a body of the second anchor object in the second live-streaming window.

In some embodiments, at least one computer program/instruction, when executed by the processor of the electronic device, causes the electronic device to perform:
using an expression special effect corresponding to the facial expression of the first anchor object as an interactive element in the interactive special effect, the interactive special effect being that the expression special effect moves from the face of the first anchor object to the body of the second anchor object in the second live-streaming window.

In some embodiments, the action content is a body action of the first anchor object, the body action including at least one of a facial expression, a head action, a limb action, or a torso action, and the preset special effect is a body special effect, the body special effect being a movement process of an interactive prop; and at least one computer program/instruction, when executed by the processor of the electronic device, causes the electronic device to perform:
determining, in the case that the interactive prop touches the first live-streaming window, a moving track of the interactive prop based on an action direction of the body action; and
determining the interactive special effect based on the moving track, the interactive special effect being that the interactive prop starts from the first live-streaming window and moves to a target position of the second live-streaming window along the moving track.

In some embodiments, the target position of the second live-streaming window is a position where a boundary of the second live-streaming window is located, and at least one computer program/instruction, when executed by the processor of the electronic device, causes the electronic device to perform:
updating and displaying a score of the first anchor object in the case that the interactive prop touches the boundary of the second live-streaming window; and
updating and displaying, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, the target position of the second live-streaming window is a position where a virtual target ring of the second live-streaming window is located; and at least one computer program/instruction, when executed by the processor of the electronic device, causes the electronic device to perform:
displaying at least one virtual target ring of the second live-streaming window, each virtual target ring corresponding to a score; and
updating and displaying, in the case that the interactive prop touches the virtual target ring, a score of the first anchor object based on a score of the virtual target ring.

In some embodiments, at least one computer program/instruction, when executed by the processor of the electronic device, causes the electronic device to perform:
detecting a boundary of the first live-streaming window based on a position of the first live-streaming window; and
determining, in the case that a boundary of the interactive prop overlaps the boundary of the first live-streaming window, that the interactive prop touches the first live-streaming window.

In some embodiments, at least one computer program/instruction, when executed by the processor of the electronic device, causes the electronic device to perform:
determining, in the case that the interactive prop touches the first live-streaming window, a moving speed of the interactive prop based on an action parameter of the body action and an elastic parameter of the interactive prop; and
determining, based on a boundary of the interactive prop and a boundary of the first live-streaming window, a collision position of the interactive prop with the first live-streaming window; and
determining the interactive special effect based on the moving track, the moving speed, and the collision position, the interactive special effect being that the interactive prop starts from the collision position and moves to the target position of the second live-streaming window at the moving speed along the moving track.

In some embodiments, the interactive special effect includes a first interactive element and a second interactive element, the first interactive element being configured to represent interaction progress, and the second interactive element being configured to present an interaction mode between anchor objects; and at least one computer program/instruction, when executed by the processor of the electronic device, causes the electronic device to perform:
displaying, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in the case that an interaction duration reaches a preset duration, that the first interactive element is converted from the first form to a second form, the second form being configured to represent that the first interactive element is currently in an interaction quit state; and
using, in the case that the first interactive element is in the second form, an anchor object in a live-streaming window where the second interactive element is currently located as a target object.

In some embodiments, at least one computer program/instruction, when executed by the processor of the electronic device, causes the electronic device to perform:
displaying a preset quantity of virtual bricks and the interactive element;
displaying, based on an action direction of the preset action of the first anchor object, a movement of the first live-streaming window according to the action direction;
displaying, in the case that the first live-streaming window touches the interactive element, that the interactive element rebounds from the first live-streaming window; and
displaying, in the case that the interactive element touches the virtual bricks, a disappearing special effect of the virtual bricks.

In some embodiments, at least one computer program/instruction, when executed by the processor of the electronic device, causes the electronic device to perform:
displaying, in the case that the interactive element touches the second live-streaming window, that the interactive element rebounds from the second live-streaming window.

The embodiments of the present disclosure further provide a method for live streaming interaction. The method includes:
displaying a first anchor object in a first live-streaming window and a second anchor object in at least one second live-streaming window;
determining, in the case that the first anchor object in the first live-streaming window makes a preset action, an interactive special effect associated with the preset action, the interactive special effect including an interactive element; and
displaying that the interactive element moves from the first live-streaming window to a second live-streaming window indicated by the preset action, a movement process of the interactive element being the interactive special effect, and the interactive special effect being configured to present an interactive effect of the first anchor object in the first live-streaming window and the second anchor object in the second live-streaming window.

In some embodiments, determining, in the case that the first anchor object in the first live-streaming window makes the preset action, the interactive special effect associated with the preset action includes:
acquiring, in the case that the first anchor object in the first live-streaming window makes the preset action, an action content and an action direction of the first anchor object by recognizing the preset action of the first anchor object; and
determining the interactive special effect based on the action content and at least one of the action direction or a preset special effect; and
displaying that the interactive element moves from the first live-streaming window to the second live-streaming window indicated by the preset action includes:
displaying that the interactive element moves from the first live-streaming window to the second live-streaming window indicated by the action direction.

In some embodiments, the action content is a body action of the first anchor object, the body action including at least one of a facial expression, a head action, a limb action, or a torso action; and
determining the interactive special effect based on the action content and at least one of the action direction or the preset special effect includes:
determining the interactive special effect based on the body action of the first anchor object and the body special effect.

In some embodiments, the body action is a facial expression of the first anchor object, and the body special effect is an expression special effect; and
determining the interactive special effect based on the body action of the first anchor object and the body special effect includes:
determining the interactive special effect based on the facial expression of the first anchor object and the expression special effect.

In some embodiments, determining the interactive special effect based on the facial expression of the first anchor object and the expression special effect includes:
generating, based on the facial expression of the first anchor object and the expression special effect, the interactive special effect, the interactive element being a facial part of a head picture of the first anchor object; and
displaying that the interactive element moves from the first live-streaming window to the second live-streaming window indicated by the action direction includes:
displaying that the interactive element moves from the face of the first anchor object to the body of the second anchor object in the second live-streaming window indicated by the action direction, the facial expression of the first anchor object in the head picture of the first anchor object being deformed.

In some embodiments, determining the interactive special effect based on the facial expression of the first anchor object and the expression special effect includes:
using an expression special effect corresponding to the facial expression of the first anchor object as an interactive element in the interactive special effect; and
displaying that the interactive element moves from the first live-streaming window to the second live-streaming window indicated by the action direction includes:
displaying that the expression special effect moves from the face of the first anchor object to the body of the second anchor object in the second live-streaming window indicated by the action direction.

In some embodiments, the body special effect refers to the movement process of an interactive prop;
determining the interactive special effect based on the action content and at least one of the action direction or the preset special effect includes:
determining, in the case that the interactive prop touches the first live-streaming window, the action direction of the body action; and
determining a moving track of the interactive prop based on the action direction, and forming the interactive special effect in the movement process of the interactive prop along the moving track; and
displaying that the interactive element moves from the first live-streaming window to the second live-streaming window indicated by the action direction includes:
displaying that the interactive prop starts from the first live-streaming window and moves to a relevant position of the second live-streaming window along the moving track.

In some embodiments, the relevant position of the second live-streaming window is a position where a frame of the second live-streaming window is located, and the method further includes at least one of:
updating and displaying the score of the first anchor object in the case that the interactive prop touches the boundary of the second live-streaming window; and
updating and displaying, in the case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

In some embodiments, the relevant position of the second live-streaming window is a position where a virtual target ring of the second live-streaming window is located; and
the method further includes:
displaying at least one virtual target ring, each virtual target ring corresponding to a score; and
updating and displaying, in the case that the interactive prop touches the virtual target ring, a score of the first anchor object based on a score of the virtual target ring.

In some embodiments, the method further includes:
detecting a boundary of the first live-streaming window based on a position of the first live-streaming window; and
determining, in the case that a boundary of the interactive prop overlaps the boundary of the first live-streaming window, that the interactive prop touches the first live-streaming window.

In some embodiments, determining, in the case that the interactive prop touches the first live-streaming window, the action direction of the body action includes:
acquiring, in the case that the interactive prop touches the first live-streaming window, the action direction and the action parameter of the body action by recognizing the body action;
the method further includes:
determining, based on a boundary of the interactive prop and a boundary of the first live-streaming window, a collision position of the interactive prop with the first live-streaming window; and
determining a moving speed of the interactive prop based on an action parameter of the body action and an elastic parameter of the interactive prop; and
displaying that the interactive prop starts from the first live-streaming window and moves to the relevant position of the second live-streaming window along the moving track includes:
displaying that the interactive prop starts from the collision position and moves to the relevant position of the second live-streaming window at the moving speed along the moving track corresponding to the action direction.

In some embodiments, the interactive special effect includes a first interactive element and a second interactive element, the first interactive element being configured to represent interaction progress, and the second interactive element being configured to present an interaction mode between anchor objects; and
displaying that the interactive element moves from the first live-streaming window to the second live-streaming window indicated by the action direction includes:
displaying, for any anchor object, in the case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in the case that an interaction duration reaches a preset duration, that the first interactive element is converted from the first form to a second form, the second form being configured to represent that the first interactive element is currently in an interaction quit state; and
using, in the case that the first interactive element is in the second form, an anchor object in a live-streaming window where the second interactive element is currently located as a target object.

In some embodiments, the method further includes:
displaying a preset quantity of virtual bricks and the interactive element;
displaying, based on an action direction of the preset action of the first anchor object, a movement of the first live-streaming window according to the action direction;
displaying, in the case that the first live-streaming window touches the interactive element, that the interactive element rebounds from the first live-streaming window; and
displaying, in the case that the interactive element touches the virtual bricks, a disappearing special effect of the virtual bricks.

Other embodiments of the present disclosure are apparent to those skilled in the art from consideration of the specification and practice of the present invention disclosed herein. The present disclosure is intended to cover any variations, uses, or adaptations of the present disclosure following the general principles of the present disclosure and including known common knowledge or customary technical means undisclosed in the art of the present disclosure. The specification and embodiments are provided for illustrative purposes only, and the true scope and spirit of the present disclosure are indicated by the following claims.

It should be understood that the present disclosure is not limited to the precise arrangements that have been described above and illustrated in the accompanying drawings, and that various modifications and changes can be made without departing from the scope thereof. The scope of the present disclosure is limited solely by the appended claims.

What is claimed is:

1. A method for live streaming interaction, performed by a terminal of a first anchor object, comprising:
displaying, in a live-streaming page, the first anchor object in a first live-streaming window and a second anchor object in a second live-streaming window;
determining, in a case that the first anchor object in the first live-streaming window makes a preset action, an interactive special effect associated with the preset action, wherein the interactive special effect comprises an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

2. The method for live streaming interaction according to claim 1, wherein said determining, in the case that the first anchor object in the first live-streaming window makes the preset action, the interactive special effect associated with the preset action comprises:
acquiring, in the case that the first anchor object in the first live-streaming window makes the preset action, an action content and an action direction by recognizing the preset action; and
determining the interactive special effect based on the action content and at least one of the action direction or a preset special effect.

3. The method for live streaming interaction according to claim 2, wherein the action direction is to indicate the second live-streaming window; and said determining the interactive special effect based on the action content and at least one of the action direction or the preset special effect comprises:
determining the interactive special effect based on the action direction, wherein the interactive special effect is that the interactive element moves from the first live-streaming window to the second live-streaming window indicated by the action direction.

4. The method for live streaming interaction according to claim 2, wherein the action content is a body action of the first anchor object, the body action comprising at least one of a facial expression, a head action, a limb action, or a torso action, and the preset special effect is a body special effect; and said determining the interactive special effect based on the action content and at least one of the action direction or the preset special effect comprises:
determining the interactive special effect based on the body action of the first anchor object and the body special effect.

5. The method for live streaming interaction according to claim 4, wherein the body action is a facial expression of the first anchor object, and the body special effect is an expression special effect; and said determining the interactive special effect based on the body action of the first anchor object and the body special effect comprises:
determining the interactive special effect based on the facial expression of the first anchor object and the expression special effect.

6. The method for live streaming interaction according to claim 5, wherein said determining the interactive special effect based on the facial expression of the first anchor object and the expression special effect comprises:
generating, based on the facial expression of the first anchor object and the expression special effect, an interactive special effect comprising the interactive element, wherein the interactive element is a facial part of the first anchor object, and the interactive special effect is that the facial part of the first anchor object moves from a face of the first anchor object to a body of the second anchor object in the second live-streaming window.

7. The method for live streaming interaction according to claim 5, wherein said determining the interactive special effect based on the facial expression of the first anchor object and the expression special effect comprises:
using an expression special effect corresponding to the facial expression of the first anchor object as an interactive element in the interactive special effect, wherein the interactive special effect is that the expression special effect moves from a face of the first anchor object to a body of the second anchor object in the second live-streaming window.

8. The method for live streaming interaction according to claim 2, wherein the action content is a body action of the first anchor object, the body action comprising at least one of a facial expression, a head action, a limb action, or a torso action, and the preset special effect is a body special effect, wherein the interactive element is an interactive prop, the body special effect is a movement process of an interactive prop; and said determining the interactive special effect based on the action content and at least one of the action direction or the preset special effect comprises:
determining, in a case that the interactive prop touches the first live-streaming window, a moving track of the interactive prop based on an action direction of the body action; and
determining the interactive special effect based on the moving track, the interactive special effect being that the interactive prop starts from the first live-streaming window and moves to a target position of the second live-streaming window along the moving track.

9. The method for live streaming interaction according to claim 8, wherein the target position of the second live-streaming window is a position where a boundary of the second live-streaming window is located, and the method further comprises at least one of:
updating and displaying a score of the first anchor object in a case that the interactive prop touches the boundary of the second live-streaming window; and
updating and displaying, in a case that the interactive prop does not touch the boundary of the second live-streaming window, an interaction state of the second anchor object in the second live-streaming window from a first state to a second state, the first state indicating that the second anchor object is in an interaction state, and the second state indicating that the second anchor object is in an interaction quit state.

10. The method for live streaming interaction according to claim 8, wherein the target position of the second live-streaming window is a position where a virtual target ring corresponding to the second live-streaming window is located; and the method further comprises:
displaying at least one virtual target ring of the second live-streaming window, each virtual target ring corresponding to a score; and
updating and displaying, in a case that the interactive prop touches the virtual target ring, a score of the first anchor object based on a score of the virtual target ring.

11. The method for live streaming interaction according to claim 8, further comprising:
detecting a boundary of the first live-streaming window based on a position of the first live-streaming window; and
determining, in a case that a boundary of the interactive prop overlaps the boundary of the first live-streaming window, that the interactive prop touches the first live-streaming window.

12. The method for live streaming interaction according to claim 8, further comprising:
determining, in a case that the interactive prop touches the first live-streaming window, a moving speed of the interactive prop based on an action parameter of the body action and an elastic parameter of the interactive prop; and
determining, based on a boundary of the interactive prop and a boundary of the first live-streaming window, a collision position of the interactive prop with the first live-streaming window; and
said determining the interactive special effect based on the moving track comprises:
determining the interactive special effect based on the moving track, the moving speed, and the collision position, the interactive special effect being that the interactive prop starts from the collision position and moves to the target position of the second live-streaming window at the moving speed along the moving track.

13. The method for live streaming interaction according to claim 1, wherein the interactive special effect comprises a first interactive element and a second interactive element, the first interactive element being configured to represent interaction progress, and the second interactive element being configured to present an interaction mode between anchor objects; and said displaying the interactive special effect comprises:
displaying, for any anchor object, in a case that the first interactive element is in a first form, a movement of the second interactive element from a live-streaming window of the anchor object to a live-streaming window indicated by an action direction of a preset action of the anchor object based on the action direction, the first form being configured to represent that the first interactive element is currently in an interaction state;
displaying, in a case that an interaction duration reaches a preset duration, that the first interactive element is converted from the first form to a second form, the second form being configured to represent that the first interactive element is currently in an interaction quit state; and
using, in a case that the first interactive element is in the second form, an anchor object in a live-streaming window where the second interactive element is currently located as a target object.

14. The method for live streaming interaction according to claim 1, further comprising:
displaying a preset quantity of virtual bricks and the interactive element;
displaying, based on an action direction of the preset action of the first anchor object, a movement of the first live-streaming window according to the action direction;
displaying, in a case that the first live-streaming window touches the interactive element, that the interactive element rebounds from the first live-streaming window; and
displaying, in a case that the interactive element touches the virtual bricks, a disappearing special effect of the virtual bricks.

15. The method for live streaming interaction according to claim 14, further comprising:
displaying, based on an action direction of the preset action of the second anchor object, a movement of the second live-streaming window according to the action direction, wherein the action direction of the preset action of the second anchor object is different from the direction of the preset action of the first anchor object; displaying, in a case that the interactive element touches the second live-streaming window, that the interactive element rebounds from the second live-streaming window; and
displaying, in a case that the interactive element touches the virtual bricks, a disappearing special effect of the virtual bricks.

16. A method for live streaming interaction, performed by a terminal of a first anchor object in a live-streaming room, comprising:
displaying, on a live-streaming page, the first anchor object in a first live-streaming window and a second anchor object in a second live-streaming window;
in a case that the first anchor object in the first live-streaming window makes a preset action, recognizing the preset action; and acquiring an action content and an action direction, wherein the preset action is a body action;
determining an interactive special effect associated with the preset action based on the action content and the action direction, wherein the interactive special effect comprising an interactive element;
rendering the interactive special effect locally in the terminal;
adding data of the interactive special effect to a live-streaming data stream to push the live-streaming data stream to a terminal of the second anchor object and terminals of all viewer objects in the live-streaming rooms such that the terminal of the second anchor object and the terminals of all viewer objects in the live-streaming rooms are capable of displaying the interactive special effect; and
displaying the interactive special effect, wherein the interactive special effect is a movement of the interactive element from the first live-streaming window to the second live-streaming window.

17. The method for live streaming interaction according to claim 16, wherein recognizing the preset action; and acquiring an action content and an action direction comprising:
capturing the body action of the first anchor object;
in a case that the body action is a facial expression or a head action, recognizing a key point in a face of the first anchor object through a facial action recognition system to determine an action track of the key point in the face of the first anchor object to acquire the head action of the first anchor object and the action direction indicated by the head action;
in a case that the body action is a limb action or a torso action, recognizing a key point in a limb or a torso of the first anchor object through a human body recognition system to determine an action track of the key point in the limb or the torso of the first anchor object to acquire the limb action or the torso action of the first anchor object and the action direction indicated by the limb action or the torso action.

18. An electronic device, comprising:
one or more processors; and
a memory configured to store one or more program codes executable by the one or more processors,
wherein the one or more processors, when loading and executing the one or more program codes, are caused to perform:
displaying, on a live-streaming page, a first anchor object in a first live-streaming window and a second anchor object in a second live-streaming window;
determining, in a case that the first anchor object in the first live-streaming window makes a preset action, an interactive special effect associated with the preset action, the interactive special effect comprising an interactive element; and
displaying the interactive special effect, the interactive special effect being that the interactive element moves from the first live-streaming window to the second live-streaming window, and the interactive special effect being configured to present an interactive effect of the first anchor object in the first live-streaming window and the second anchor object in the second live-streaming window.

19. The electronic device according to claim 18, wherein the one or more processors, when loading and executing the one or more program codes, are caused to perform:
acquiring, in the case that the first anchor object in the first live-streaming window makes the preset action, an action content and an action direction by recognizing the preset action; and
determining the interactive special effect based on the action content and at least one of the action direction or a preset special effect.

20. The electronic device according to claim 19, wherein the action direction is to indicate the second live-streaming window; and the one or more processors, when loading and executing the one or more program codes, are caused to perform:
determining the interactive special effect based on the action direction, the interactive special effect being that the interactive element moves from the first live-streaming window to the second live-streaming window indicated by the action direction; wherein the action content is a body action of the first anchor object, the body action comprising at least one of a facial expression, a head action, a limb action, or a torso action, and the preset special effect is a body special effect; and the one or more processors, when loading and executing the one or more program codes, are caused to perform:
determining the interactive special effect based on the body action of the first anchor object and the body special effect.
